(19) United States
(12) Patent Application Publication
(10) Pub. No.: US 2026/0189179 A1
(43) Pub. Date: Jul. 2, 2026

(54) SYSTEMS AND METHODS FOR CONFIGURING THREE-DIMENSIONAL PHOTOVOLTAIC MODULES

(71) Applicant: Solbuz Energy Ltd., Gizo (IL)

(72) Inventors: Yitzhak LIECHTENSTEIN, Zichron ya'acov (IL); Ofer AVNI, Gizo (IL)

(73) Assignee: Solbuz Energy Ltd., Gizo (IL)

(21) Appl. No.: 19/460,433

(22) Filed: Jan. 27, 2026

Related U.S. Application Data
(63) Continuation-in-part of application No. 19/121,427.
(60) Provisional application No. 63/384,433, filed on Nov. 20, 2022.
(60) Provisional application No. 63/538,517, filed on Sep. 15, 2023.
(60) Provisional application No. 63/749,719, filed on Jan. 27, 2025.

(51) Int. Cl. H02S 20/30; H02S 40/22

(52) U.S. Cl. CPC H02S 20/30; H02S 40/22

(57) ABSTRACT

An array of lengthened photovoltaic modules is disclosed. The modules or cell strips are comprised of bifacial photovoltaic cells. A deployment angle and a gap between adjacent modules is set so that a portion of light incident on the forward face of each module is reflected onto a rear face of an adjacent module in the array. The modules are separated at a uniform gap. At summer zenith, most solar radiation directed toward the array contacts an LPM, and no solar radiation contacts a deployment surface on which the array is mounted. The modules may be designed in a zigzag shape, wherein the module is comprised of V-shaped units of photovoltaic cells, wherein, within each V-shaped unit, the opposing faces are electrically connected in parallel, and adjacent V-shaped units are connected in series.

### RELATED APPLICATIONS

This application is a Continuation in Part of U.S. patent application Ser. No. 19/121,427 filed on 16 Apr. 2025, which is a national stage of International Patent Application no. PCT/IB2023/000727, filed on 15 Nov. 2023, which claims the benefit of priority under 35 USC § 119(e) of U.S. Provisional Patent Application No. 63/384,433, filed on 20 Nov. 2022, and U.S. Provisional Patent Application No. 63/538,517, filed on 15 Sep. 2023, the entire contents of which is incorporated herein by reference in its entirety. In addition, this application claims the benefit of priority under 35 USC § 119(e) of U.S. Provisional Patent Application No. 63/749,719, filed on 27 Jan. 2025, the entire contents of which is incorporated herein by reference in its entirety

### TECHNOLOGICAL FIELD

The present disclosure relates to the field of solar energy, and more specifically, but not exclusively, to systems and methods for arrangement and installation of lengthened profile modules based on photovoltaic cells. In particular, the present disclosure addresses innovative geometric configurations for three-dimensional photovoltaic modules, and electrical engineering solutions for enablement of such configurations.

### BACKGROUND

International Patent Application PCT/IB2023/000727, published as WO2024105451 (hereinafter, the '727 application), describes continuous profile modules (CPM) of photovoltaic (PV) modules. The '727 application also describes a system and method to generate more energy from a deployment surface by condensing the PV cells deployed with immunity to the shading effect caused by self-shading. The shading effect is the extreme reduction in power that occurs when a small shadow is cast on a regular PV panel and dramatically reduces the power it generates since when PV cells are electrically connected in series and a shadow is cast on one of them, it reduces the current for all of them. Immunity to self-shading means that the impact of the shading is approximately linear with the level of shading and does not create a shading effect. This means that if a PV module has shadow over 20% of its surface, the power will be reduced by 20% approximately, and no more.

The '727 application describes such solutions utilizing so-called “new” types of PV panels (which are PV panels with immunity to self-shading) as well as with continuous profile modules (called here lengthened profile modules).

While solutions described in the '727 application have substantial utility, the solutions described in the '727 application do not take full advantage of all of the configurations and permutations available for implementation of three-dimensional photovoltaic panels.

For example, the '727 application discloses power advantages resulting separately from the V shape profile of modules, or from the density of the flat profile solutions, respectively. However, the '727 application does not consider other three-dimensional implementations that can combine these strategies. The '727 application also does not consider significantly ways to implement such solutions with bifacial panels.

In addition, deploying the continuous profile modules of the '727 application might consume a lot of time and work and might have safety issues, since every such module requires two connectors. The connectors can become failure points and create safety and reliability issues for the entire PV system and the entire roof. In addition, assembling all the modules on the roof may require a lot of work in dangerous conditions (e.g. sloped roofs). The need to set the modules in different (customized) parameters such as their diagonal direction, tune the angle to which they are facing for each deployment surface according to roof slope steepness, direction and latitude, creates many challenges for the manufacturing and the deployment processes as well. The '727application provides a method to decide on some parameters, but does not provide a solution for all scenarios.

Application '727 is herein incorporated by reference in its entirety.

### SUMMARY OF THE INVENTION

The present disclosure describes systems and methods for manufacturing and deployment of lengthened profile modules (LPM), and for increasing the efficiency of power generation per square meter for such modules.

In particular, the present disclosure introduces systems and methods for implementation of bifacial modules. While bifacial panels are known, the exposure of the rear side of the bifacial panels is typically limited to solar ambient radiation (albedo irradiance). This is because, in typical deployments, adjacent panels or modules are intentionally spaced from each other to avoid the shading effect. This, in turn, limits the ability to utilize reflections off the front side of one bifacial module onto a rear side of an adjacent bifacial module. In the present disclosure, since the effect of shading is minimized and the modules are relatively close together, the modules may be specially designed to maximize the exposure on both sides of a bifacial panel. For example, the modules may be designed in an angled manner, with mirrors at the base of the front portion of the panel that reflect the light onto the rear of an adjacent panel. Other configurations are possible as will be described further herein in connection with FIGS. 36-37 and 54-56.

In particular embodiments, the present disclosure addresses the optimal tilt angle and spacing for bifacial panels in which the shading effect is not a concern. The ideal tilt angle and spacing of bifacial photovoltaic panels has been discussed extensively in the literature. However, such disclosures generally relate to bifacial panels in which the back side of the panel receives only ambient radiation (albedo irradiance). There is no discussion in the literature regarding the tilt angle and spacing in which the panels are so closely spaced so as to generate shading of the front face, while at the same time providing reflection off of the front face of one panel to the rear face of the adjacent panel. In particular, maximal energetic efficiency may be maintained upon the following conditions: (1) the panels are spaced sufficiently close together so that most solar radiation throughout the year is captured; and (2) the front faces of panels are tilted relative to the angle of the incoming sun rays, at summer zenith, at approximately 142°. Since, outside the tropical region, the angle of incoming sun changes with latitude, the optimal tilt angle relative to the surface of deployment increases with latitude, in order to preserve the angle relative to the incoming sun rays. Under these circumstances, all solar rays reach the front face of the solar modules, and, in addition, a high percentage of the incoming rays are reflected to the rear faces of the panels.

The bifacial panels may be implemented, in some embodiments, with the types of panels described in the '727 application as “new PV panels,” namely solar panels are immune from the shading effect due to each row of PV cells in a given new panel being electrically connected in parallel to the other rows of PV cells in that panel. In such embodiments, the panels may be placed at a stiff tilting and relatively close together in order to maximize the energy output for a given area. When such panels are fitted with bifacial PV cells, the energetic output is further improved. This configuration is discussed in FIG. 58.

The present disclosure also discusses three-dimensional photovoltaic modules arranged in a zigzag manner. The zigzag configuration comprises multiple V-shaped units arranged in a line, with all PV cells inside of the V unit being connected in parallel with each other, and all V units are connected in series with each other. Such zigzag-shaped profiles (referred to herein as Z3DP) may be arranged in an array. The Z3DP configuration is especially efficient since it combines the light trapping of a V unit with light trapping of a bifacial unit, generating much more energy per square meter, and increases energy supply in the morning and the evening. The Z3DP configuration is discussed herein at FIGS. 44-48.

The present disclosure further describes pallets comprising an array of multiple lengthened photovoltaic modules of the same length connected with integral connectors on a skeleton, thus creating a rectangular shape (pallets). Similar structures like pallets, which incorporate different size LPMs, are referred to herein as free-shape solar pallets (FSSP). The FSSPs may assume any shape and may thus be tailored to the dimensions of any roof. The pallets and FSSPs may also be configured on various support materials that enable easy installation and maintenance.

Moreover, the present disclosure introduces solutions for electrical engineering and mounting of the three-dimensional photovoltaic modules described herein. Mounting solutions described herein include mounting the LPMs on gamma-shaped supports and mounting the LPMs on an L-shaped or bent configuration within a base or track. The mounting solutions further include strategies for optimizing the diagonal angle of the LPMs, as well as their tilting angle relative to the surface on which they are mounted and the gaps between them, based on the latitude, azimuth, and tilt of the deployment surface. Advantageously, the mounting devices are located entirely on the bottom of the solar panels, and do not include elements that cast shade on the PV modules, even at low sun angles. The present disclosure further discloses strategies for forming integral connectors between photovoltaic modules, which are much safer and reliable than regular connectors, and which enables formation of the pallets and free-shaped solar pallets.

The systems and methods described herein enable, without limitation, the following advantages over known systems: (1) increased energy production relative to surface area; (2) maximal energy production from bifacial cells in an array, including direct reflection from adjacent modules, from reflectors, and from surrounding sunlight; (3) a support structure for an array of PV cells with a reflector along the bottom edge, and including a method of integral connection between LPMs that enables different shapes of pallets; (4) maintaining continuity in a lengthened photovoltaic module, without breaks that reduce the absorption or the uniformity of the light and shade, which are essential to avoid electrical mismatch and current bottlenecks; (5) a structure that enables shading from the front and increased and uniform rear light on all cells; (6) improved cooling of the PV modules due to tilting the modules in an higher angle than is conventional for panels which are not shading protected, improved self-cleaning in rain for the same reason, and improved endurance with respect to environmental conditions and hailstorms; (7) A support structure under the photovoltaic modules that does not cast shadows on the photovoltaic cells at the edge of the PV strip; (8) integration of modules of different lengths with a continuous connection, in order to generate FSSPs in different geometric shapes (triangles, trapezoids, etc.); (9) ability to customize the modules'orientation to desired azimuth and tilting angles, and to set the gaps between the modules according to the local environmental conditions and daily power distribution preferences; (10) setting gaps and angles according to the angle of the sun at the summer zenith; (11) setting gaps and angles so that the photovoltaic modules will occupy three-dimensional space relative to their deployment surface; and (12) deployment solutions on flat roofs, sloped roofs, fences, walls, pergolas, and solar fields.

According to a first aspect, an array of lengthened photovoltaic modules is disclosed. A deployment angle and a gap between adjacent modules is set so that a portion of light incident on the forward face of each module is reflected onto a rear face of an adjacent module in the array.

The array may include a reflective surface on the bottom of the array that reflects light to the rear face of the adjacent lengthened photovoltaic module. The reflective surface may include a plurality of reflective surfaces, wherein each reflective surface is configured at a base of a lengthened photovoltaic module. The reflective surface may also include a uniform surface arranged at a bottom of the sealed PV modules or PV cell strips. The reflective surface may include one or more of reflective paint, a reflective stick, or a mirror or a mirror level polished aluminum.

The deployment angle may be set such that an angle of incidence of solar radiation at summer zenith onto a front face of the bifacial sealed PV modules or PV cell strips is approximately 142±20 degrees. This deployment angle maximizes overall absorption by both the forward and rear facing photovoltaic modules.

Individual photovoltaic modules may be separated from each other at a uniform gap. The uniform gap may be set so as to ensure that, at summer zenith, all solar radiation directed toward the array contacts an LPM, and no solar radiation contacts a deployment surface on which the array is mounted. The uniform gap may be modified to be up to ±50% of a gap and still ensure that, at summer zenith, most solar radiation will not contact the deployment surface on which the array is mounted. The gap may be sufficiently small so as to cause self-shading between adjacent modules at winter at least for 20%-40% of winter active hours (winter active hours means day light hours during the shortest day of the year). Because the photovoltaic modules are shading-protected, the advantages of setting the gap at summer zenith override the limited use of some PV cells during winter.

The skeleton may comprise a support frame that provides structural support to the LPMs and their PV cells, wherein the support is entirely configured at the edge of the LPM that has the lowest exposure to the sunlight throughout the year.

The array may further comprise, at edges of the array, one or more blank or dummy cells that provide reflection on adjacent photovoltaic surfaces without having their own photovoltaic surfaces.

In a second implementation, an array of shade-protected photovoltaic panels is disclosed, wherein a deployment angle and a gap between adjacent modules is set so that a portion of light incident on the forward face of each module is reflected onto a rear face of an adjacent module in the array.

In a third implementation, an array of photovoltaic modules arranged in a zigzag shape is disclosed. The module is comprised of a plurality of V-shaped units of photovoltaic cells. Within each V-shaped unit, the opposing faces are electrically connected in parallel, and adjacent V-shaped units are connected in series. The modules may be mounted in parallel.

Each V-shaped unit may be comprised of bifacial photovoltaic modules, and wherein an angle and a gap between adjacent modules is set so that a portion of light incident on the forward face of each module is reflected onto a rear face of an adjacent module in the array.

The array may include a reflective surface on the bottom of the array that reflects light to the rear face of the adjacent lengthened photovoltaic module.

Optionally, within each V-shaped unit, front conduction wires of PV cells, on a side that is designed to face the sun, are connected together front-to-front, and back conduction wires of the PV cells are connected back-to-back, and, between different V-shaped units, the back conduction wires of one V-shaped unit are connected to the front conduction wires of the next V-shaped unit.

A method of forming the photovoltaic modules of the array of zigzag shaped modules may include: while stringing the wiring, flipping between front and back wiring of the photovoltaic cells every two cells; positioning the photovoltaic modules in a V-shape, laminating the cells, and setting the cells in a zigzag structure.

Optionally, for the array of modules in a solar farm (whether lengthened or zigzag configuration), each respective module comprises parallel rows of photovoltaic cells, and wherein all photovoltaic cells at the same height from different modules are connected in series. In such embodiments, each row may comprise half of a string, wherein a string is a group of photovoltaic cells connected in series with sufficient voltage generation capacity to enter an inverter connected to the array, so that current that flows within one row and out another row creates a full string. In addition, there may be a main avenue of string inverters, and wiring connecting the main avenue to each row that comprises half a string. All the string inverters may be located along an avenue on one edge of the array. This configuration minimizes the wiring and thus improves the safety and efficiency of the array.

In another implementation, an array of photovoltaic modules is disclosed, wherein a gap between adjacent photovoltaic modules is set so that the adjacent modules form a three-dimensional array, wherein a combined surface area of the forward faces of the modules in the array is greater than a footprint of the array, by at least 1%, in any possible tilting or rotation. For each such array, the photovoltaic modules may be electronically connected in series and mechanically mounted in parallel, so that self-shading between adjacent reduces energetic output only proportionally to the degree of self-shading and does not create an energy bottleneck. The gap may be sufficiently small so as to cause at least self-shading between adjacent modules for 20% of winter active hours. The array may be arranged at a tilting angle based on the general absorption direction of the latitude in which it is located and considerations of local shading.

In another implementation, a free shaped solar pallet is disclosed. The pallet includes a skeleton; and, supported by the skeleton, a series of lengthened photovoltaic modules comprising sealed PV modules or PV cell strips that are electronically connected in series and mechanically mounted in parallel. The sealed PV modules or PV cell strips are electrically connected with integral connectors or with firm connections. The skeleton is configured to match a shape of a deployment surface.

The integral connectors may comprise bypass diodes.

The skeleton may include a plurality of gamma-shaped supports, each gamma-shaped support configured to support each panel at a predetermined height and distance relative to the other panels. The gamma-shaped supports may comprise drainage holes. The gamma-shaped supports may comprise reflective surfaces configured to reflect sunlight toward adjacent photovoltaic panels in the array.

The photovoltaic modules may be configured as roof shingles.

In preferred embodiments, no part of the skeleton casts shade on any part of the photovoltaic modules from the front and from the back.

The skeleton may include a base including slots for receiving the modules therein, and adjustment strips that enable adjustment of the gap between adjacent modules.

The pallet may include a snap-rail connection mechanism between the modules and the base, and/or a tilting mechanism for tilting the modules relative to the base.

### BRIEF DESCRIPTION OF THE DRAWINGS

FIGS. 1-7 (optimizing spacing and angles): FIG. 1 illustrates rows of PV panels deployed on a surface according to conventional, prior art spacing; FIG. 2 shows rows of PV modules arrayed with higher density on a flat surface, according to embodiments of the present disclosure; FIG. 3 illustrates rows of PV modules arrayed with different density on different roof slopes, according to embodiments of the present disclosure; FIGS. 4 and 5 illustrate strategies for arraying lengthened photovoltaic modules on eastern-facing roofs; FIG. 6 illustrates placement of lengthened photovoltaic modules considering shading lines of an external shading obstacle to accommodate daily shadings; FIG. 7 illustrates an implementation of bypass diodes with high resolution to accommodate daily shading.

FIGS. 8-21 (integral connectors and formation of free-shaped solar panels): FIG. 8 illustrates integral connectors in a PV cell strip; FIG. 9 shows the integral connectors of FIG. 8 before cutting out unneeded lamination material; FIG. 10 illustrates bypass diodes in integral connectors; FIG. 11 shows an exploded view of a lamination sandwich that can support the integral connectors of FIGS. 8-10; FIG. 12 shows a PV cell strip with bypass diodes in integral connectors; FIG. 13 shows an example of a flat free-shape solar pallet (FSSP); FIG. 14 illustrates a cartridge of lengthened photovoltaic modules (LPMs) in a folded position; FIG. 15 illustrates a cartridge of LPMs in a partially opened position; FIG. 16 demonstrates deployment of a cartridge of LPMs on a roof; FIG. 17 shows how an integral connector can be cut to form tail contacts, and FIG. 18 shows connection between two tail contacts of an integral connector; FIG. 19 shows a bottom view of another type of integral connector; FIG. 20 shows an exploded view of another embodiment of an integral connector; FIG. 21 shows how the main power line in an integral connector may be comprised of the grouped electrical conducting wires of the PV cells.

FIGS. 22-24 (gamma-shaped profiles): FIG. 22 illustrates a side view of gamma-shaped profiles; FIG. 23 illustrates a perspective view of an array of gamma-shaped profiles; FIG. 24 shows a gamma-shaped profile with an extra tilt in the structure which acts as a mirror.

FIGS. 25-27 (additional embodiments of free-shaped solar pallets): FIG. 25 illustrates a module of free-shaped solar pallets (FSSP) built from gamma-shaped profiles; FIG. 26 shows an arrangement of FSSP with a rounded shape; FIG. 27 shows an arrangement of a FSSP with no frame.

FIGS. 28 and 29 illustrate methods of placement of a FSSP on a sloped roof;

FIGS. 30-37 (support and roofing solutions): FIG. 30 illustrates free-shaped solar pallets with a rubber pad underneath; FIG. 31 illustrates solar modules functioning as roof shingles; FIG. 32 illustrates the solar modules of FIG. 31 but with the same length after assembly; FIG. 33 illustrates an array of modules arranged on a base with an L-shaped profile; FIG. 34 shows free-shaped solar panels comprised of L-shaped profiles; FIG. 35 shows another view of the L-shaped profile; FIG. 36 shows lengthened photovoltaic modules arranged along a regular shape of metal roofing; FIG. 37 shows deployment of lengthened photovoltaic modules on such roofs.

FIG. 38 shows a lengthened photovoltaic module that includes bifacial PV cells and a field deployment method.

FIG. 39 shows another design example of an array of lengthened photovoltaic modules arranged on a deployment surface;

FIG. 40 shows how a free shaped solar panel may be lifted for maintenance access purposes.

FIGS. 41-43 (V-shaped panels): FIG. 41 shows a process of manufacture of a V-shaped 3D module (3DP); FIG. 42 illustrates a completed module made of V-shaped panels; FIG. 43 illustrates a schematic side view of an example of how a V-shaped panel may be designed with gaps therein to permit release of dirt;

FIGS. 44-53 (Zigzag 3d modules): FIG. 44 shows a single zigzag-shaped 3-dimensional profile (Z3DP) comprised of 3D PV units; FIG. 45 shows a cross section view of an example how the PV cells within such zigzag-shaped three-dimensional profiles may be electrically connected; FIG. 46 shows an example of an array of zigzag-shaped three-dimensional profiles; FIG. 47 shows how the same shadow occurs on all the V-shaped units; FIG. 48 shows an optional structure and method for lamination; FIG. 49 shows how three-dimensional profiles can be applied also to tilted deployment; FIG. 50 shows flat long profile modules with more than one angle; FIGS. 51 and 52 show how a zigzag-shaped three-dimensional profile may be set in a continuous setting; FIG. 53 shows a deployment concept in which string inverters are located on the main avenue;

FIGS. 54-56 (combination of mirror with zigzag 3d modules): FIG. 54 shows a side view of a deployment of a flat bifacial LPM with a mirror; FIG. 55 illustrates the effect of latitude on ideal tilt angle for bifacial modules arranged according to the principles of the present disclosure; FIG. 56 shows the same bifacial design but for the Z3DP;

FIG. 57 shows a Z3DP array comprised of arch shaped 3D PV units;

FIGS. 58 and 59 show deployment of mutual shading-protected “new” PV panels with a bifacial design including a mirror;

FIG. 60 illustrates placement of pallets with LPMs on intervening spaces between arrays of conventional panels;

FIGS. 61 and 62 illustrate a skeleton and electrical connections that are particularly well-suited for implementation of bifacial modules, including the detailed electrical connection.

### DETAILED DESCRIPTION

The present disclosure relates to the field of solar energy, and more specifically, but not exclusively, to systems and methods for arrangement and installation of lengthened profile modules based on photovoltaic cells. In particular, the present disclosure addresses innovative geometric configurations for three-dimensional photovoltaic modules, and electrical engineering solutions for enablement of such configurations, as well as increasing the efficiency of power generation per square meter.

### Definitions

All terms defined in the '727 application are used herein according to their original definition, unless otherwise defined here.

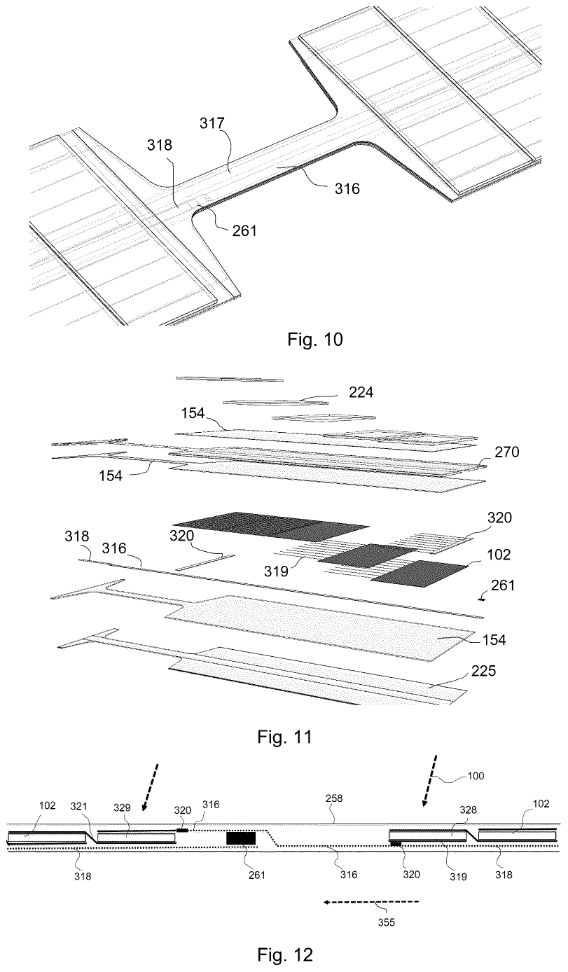

A lengthened photovoltaic module (LPM) is a PV module which is comprised of a single sealed PV module (defined below) or a PV cell strip (defined below) or a sealed PV strip (defined below), arranged within a skeleton that enables positioning of the PV cells in the required position and orientation. The skeleton is the mechanical structure of the LPM (e.g., aluminum) without the part of the sealed PV module or any encapsulated PV cells. A sealed PV module is a lengthened strip of PV cells of similar size and similar efficiency encapsulated and connected to each other in a row, in which the group of PV cells in each cross section of the strip (if there is more than one) are connected in parallel and the groups in the adjacent cross sections are connected in series. The sealed PV module has a similar structure for each PV unit from which it is comprised. A PV unit can be a single PV cell, facing a single direction or curved, or multiple such PV cells connected in parallel. This definition of a cross section refers only to the cross sections in which there is a PV cell and not to cross sections which are the connection between the groups of PV cells. A photovoltaic (PV) cell strip is a sealed PV module protected by protective tiles per each PV cell or per group of PV cells at least on the front side of the strips (i.e. the front side of the PV cells). The tiles can be made of glass or any other type of transparent material (to be called glass tiles or tiles, as seen in FIG. 10). A Sealed PV strip is similar to a sealed PV module, but it is comprised of 2 or more rows of PV cells, whereas the PV cells in each row are connected in series, and the rows are connected in parallel. In most of the embodiments in the disclosure, a sealed PV strip can be used instead of a sealed PV module, so when referring to sealed PV module, a sealed PV strip can be used instead, unless otherwise indicated. In sum, a sealed PV module may be part of a PV cell strip, which may be part of an LPM. Both sealed PV modules and the PV cell strips are described in extensive detail in the '727 application.

The PV cells and PV surface in this disclosure may have any size and be made of any photovoltaic material, including silicon, thin film, perovskite, Kesterite, CIGS, CdTe, PV tiles, bifacial, transparent PV cells, non-transparent PV cells, multi junction PV cells, any PV material sprayed on any surface or any combination thereof.

A 3-dimensional PV (3DPV) structure is a PV structure whose total PV surface size is larger than its footprint (i.e. projection) by at least 1% in any possible tilting or rotation. The footprint is measured when the collimated sunlight beam is perpendicular to a theoretical, projected flat surface on which the projection is cast). This result may be achieved through the use of condensed flat PV modules which are spaced closely together and/or by using integrated 3D PV units, as will be discussed further herein. The PV surface may be larger than the footprint in a greater dimension, for example 3%, 5%, 10% or even 20% or more. The phrase “connected in parallel” means connected electronically in parallel, and the phrase “mounted in parallel” means mounted geometrically in parallel. Positioned or mounted in parallel may include within 1 degree error or even 5 or 10 degrees. For arrays of lengthened profile modules or 3D profiles with uniform spacing, there may be variation in the spacing of up to approximately 5% or 10% difference.

Unless specified otherwise, examples in this document relate to the northern hemisphere, with the understanding that the directions may be reversed for the southern hemisphere, as applicable.

For flat PV units, the panel is considered to face the direction to which it is pointed. For 3DPs which include 3D PV units, in which the PV surface of the 3D PV unit faces more than one direction (as will be discussed infra with reference to FIGS. 41-48), the facing direction of the 3D PV unit is calculated as the sum of the vectors to which each face is facing, while the magnitude of each face vector is proportional to size of the surface of that face. This may be used for setting the optimal tilting angle of 3DPs.

### I. Principles Regarding Setting the Tilting Angle of Photovoltaic Surfaces With Shading

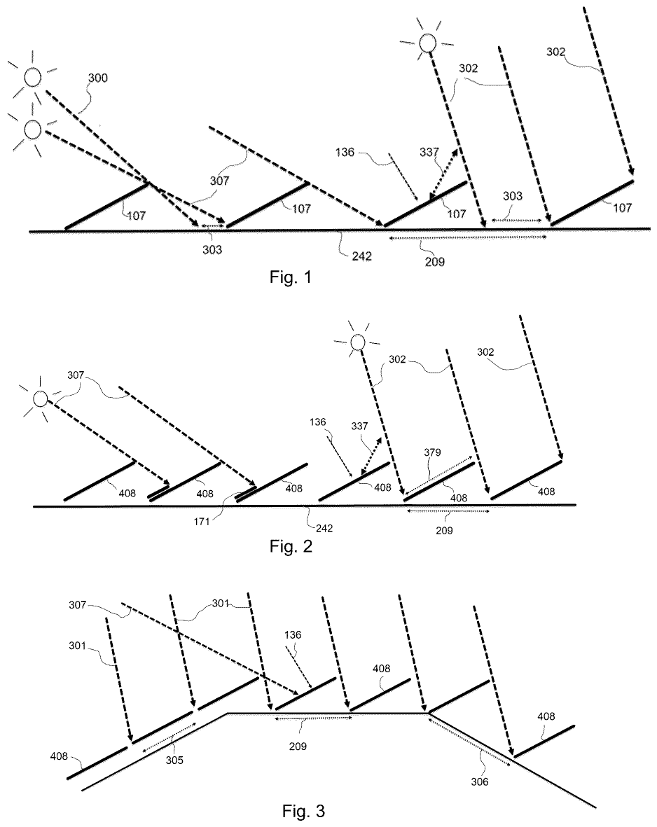

FIGS. 1-7 illustrate basic principles of setting the tilting angle and typical gap between PV panels and between modules of an array of lengthened profile modules (LPMs). The analysis herein assumes that the roof or other deployment surface on which the LPMs are to be mounted is accurately measured, including parameters such as slope steepness, direction, latitude, size and shape of the deployment surface and nearby objects or obstacles that may cast partial or full shade on the deployment surface.

In general, the best local absorption direction (including an optimal tilting angle and azimuth direction) for the PV surface to face is calculated for a given slope of the deployment surface. Parameters that affect a local absorption direction for a given surface include its steepness, direction, latitude and daily shading. For a flat horizontal surface without daily shading which faces south (i.e. tilted south), this best local absorption direction is the same as the general absorption direction. (The “general absorption direction,” sometimes called absorption direction, means the tilting angle and the azimuth in which a flat, static PV cell should be facing in order to generate maximum energy throughout the year at a specific location). For any other surface and location, the local absorption direction is the tilting angle and the azimuth in which such a flat PV cell will generate the maximum amount of energy throughout the year. “Daily shading” means shadow from a nearby obstacle that is cast during at least part of the year.

FIG. 1 shows a side view of how, in prior art arrangements, the rows of PV panels 107 are typically deployed on a deployment surface 242. The direction of sunlight 300 during winter zenith is indicated on the left side of the Figure and during summer zenith 302 is indicated on the right side of the Figure. The panels 107 are deployed with a gap 209 between them to avoid self-shading due to the typical tilting angle of the PV panels between 9:00 am to 3:00 pm at the peak winter day, whose sunlight rays are indicated as vectors 307. Typical tilting angle is the angle in which the PV panel is facing the absorption direction. This gap that is calculated based on a typical tilting angle of the panels is called the typical gap. This leading deployment concept today creates the same angle 337 between summer zenith and the PV surface. In this typical gap region, photons are wasted a little during winter zenith 300, and more during the rest of the year, while the highest number of photons is wasted 303 during summer zenith 302. Zenith means sun position around its highest daily point in the sky (e.g. noon) at a specific location. Summer zenith means the same at the longest day of the year and winter zenith is the same at the shorter day of the year. If the rows of PV panels are deployed closer to each other than the typical gap, they cause self-shading. Even a small self-shading is fatal to the energy yield of regular PV panels.

However, as described in the '727 application, LPMs that are electronically connected in series and mechanically mounted in parallel in a similar direction (or orientation) overcome the self-shading problem, provided each LPM has one PV cell in its cross section, or a group of PV cells connected in parallel, and the group of PV cells in each cross section is connected in series to the next group of PV cells in the next cross section of that LPM. The reason is that in such an array, all the PV cells are shaded in a similar manner, and none of them becomes a bottleneck for the current. Similar direction or orientation in this disclosure means an orientation which is about the same but might slightly differ due to inaccuracies and fault tolerances of the structure, the system, the deployment surface or due to the implementation or due to the assembly process, or any other reason. As a general rule, up to 5 degrees error can still be considered similar orientation, although in an ideal design it should be less than 1 degree. This definition also applies for using the phrase “similar direction” in this disclosure.

FIG. 2 shows a side view of how the solutions for the self-shading effect enable condensing the new, shading-protected PV panels or the LPMs as described in the '727 application (called there “continuous profile modules”). In order not to waste photons arriving to the deployment surface 242 the gap 209 between the flat LPMs 408 is set based on summer zenith 302 (i.e. the gaps between the LPMs are set as the maximum in which no photons collide with the deployment surface during summer zenith). This gap may be referred to herein as a gap “based on summer zenith.” The gap may differ from the gap based on summer zenith by a certain amount, even up to ±50%, while still maintaining energy benefits.

When the spacing is set according to the summer zenith, the self-shading during the rest of the year (in region 171, each of which is shaded from winter rays 307 by the PV module to the left of it) is the same for all PV cells, so it doesn't create a power bottleneck, so there is no electric mismatch and no photon energy is lost due to it. The cost of the PV cells has been reduced significantly during the last few years, making it cost-effective to condense LPMs so they will cast self-shadow on one another throughout most of the year in order to generate more energy from the same deployment surface, splitting the deployment overhead cost over many more watts. Sometimes it might not be most cost-effective to deploy such density for using all photons including during peak summer zenith and some compromise can be exercised to increase (or deviate or divert) the gap 209 by 10%, 20%, 30% or any number up to 100% in order to reduce cost by using fewer PV cells.

The gap 209 may be equal to the width of the LPM 408, or larger than it or smaller than it. For some gaps and LPM structures, the system reaches a point in which the entire structure forms a 3-dimensional array. 3-dimensional array means that the PV modules are positioned so the distance (gap) between the PV modules in consecutive rows 209 is smaller than the width of the PV surface 379 of the lengthened PV module 408. This is a measure of the density of the PV modules, and such gaps between the rows of the PV modules are significantly smaller than the typical gap when using similar size PV panels which do not have immunity to self-shading.

The reduction of the deployment gap as illustrated in FIG. 2 represents a revolutionary shift, as compared to the conventional deployment gap of FIG. 1. In the gap as shown in FIG. 1, the avoidance of self-shadowing is so important that photons are wasted throughout the year, especially in the summer months. By contrast, in the embodiment of FIG. 2, the ability to overlap PV modules without concern for self-shading allows for a significantly greater energy output per surface area of deployment.

The possible reduction percentage in the deployment gap relative to the typical gap for PV modules aimed to the general absorption direction is proportional to the latitude of where the deployment surface is located. This proportionality may be expressed according to the following formula: if X is the absolute value of the Earth latitude at the location of the deployment surface, then the gap is reduced by X% from the “typical gap” at that location. This variance in the reduction stems, in part, from the differences in the “typical gaps” at different latitudes, due to the different angle of the incoming sun radiation. As an example, at a latitude of 20°, the gap may be reduced by at least 20%, so the LPMs'density is larger by 20%. At a latitude of 30°, the gap can be reduced by at least 30%, so the LPMs'density is larger by at least 30%. At a latitude of 40°, the gap can be reduced by at least 40% and so the LPMs'density is larger by at least 40% and so on. Such a smaller gap between the rows in a dense deployment, which enables generating more power on the deployment surface, is called the improved density gap.

For latitudes between −15° to +15° this improved density gap is valid only for PV modules positioned in a tilting angle larger than 30 degrees, while for the rest of the world it is valid at any tilting angle.

The inventors of the present disclosure have discovered that 3-dimensional PV structures can generate significantly more energy per the same flux relative to a conventional PV cell that is facing the absorption direction. This is the case for LPMs (described herein at FIGS. 8-10 and elsewhere) as well as for the new, shading-protected PV panels (described herein at FIG. 54) and for Z3DPs (described herein at FIGS. 41-48 and elsewhere).

Referring to FIG. 3, the gap 209 between adjacent modules is dependent on the steepness and direction of the deployment surface, so as the slope of the deployment surface is titled more towards the absorption direction 136—this gap becomes smaller 305, and vice versa 306.

FIG. 3 shows LPMs 408 deployed on 3 types of deployment surfaces (e.g. roof). On the left there is a slope directed towards the south (southern roof), in the middle a horizontal roof and on the right a northern facing roof, all in the northern hemisphere. [A deployment surface doesn't have to be parallel to the roof. In most cases, the LPMs or any other PV modules in this invention will be deployed in a different tilting angle than the deployment surface by at least one or two degrees, or even 5 degrees.] Gaps 305, 209, and 306 differ, based on the slopes'tilting and direction of the different deployment surfaces.

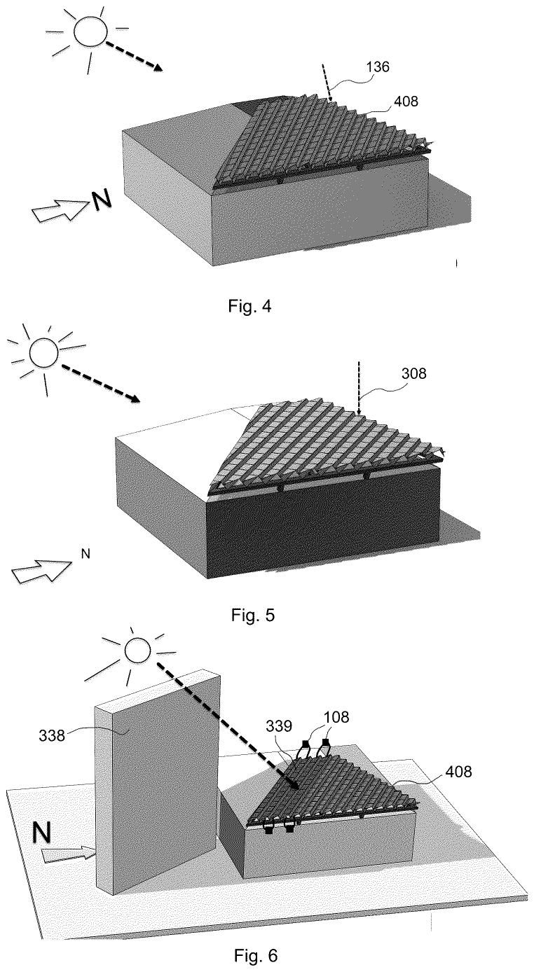

Referring to FIGS. 4 and 5, one of the ways to calculate the local absorption direction is by conducting a simulation, assuming a virtual PV panel (or a PV cell) at a specific tilting angle, direction and latitude, and calculating the power that it can generate throughout the year every minute (can be other time gaps, from every second to every hour or a few hours) according to several parameters such as the flux it receives, absorption rate at the relevant temperature, the reflection rate and other parameters for that sun angle for the specific time gap each day during the year that the deployment surface is receiving sunlight, directly or indirectly. For example, the flux is larger in the summer than in the winter and during noon vs the morning. The tilt and azimuth of the virtual PV panel that generate the most power throughout the year is selected as the typical tilting angle, typical azimuth and the corresponding local absorption direction. If different parts of a slope are shadowed differently by daily shading, their local absorption direction may be different. If there is a preference to generate more power at specific hours of the day, the calculation can be done for these hours only, or a factor can be applied to the performance in these hours to increase their weight in the overall calculation. In similar way the calculation can be conducted with preference to a specific season in the year, or a specific weather conditions, or any other parameter.

Once the typical tilting angle and the azimuth are selected (i.e. the local absorption direction), the method to calculate the diagonal direction of the deployment for that deployment surface is detailed in the '727 application.

The angle to which the PV cells face doesn't have to be exactly the local absorption direction, it can be similar to it, and it can be diverted or deviated from it by 10 degrees, 20 degrees and more based on other considerations. Such considerations can include, for example, cost reduction and weather conditions, as described below.

For example, FIG. 4 shows an eastern facing roof that was deployed with LPMs 408 based on a reference panel aimed at the general absorption direction 136 and FIG. 5 shows an eastern facing roof that was deployed with LPMs 408 based on a reference panel aimed at the local absorption direction 308.

The typical tilting angle, azimuth and the local absorption direction can also be impacted by preference for more power at specific time of the day, such as morning or evening according to customer electricity usage routine or the power rates of the grid which pays for that power or any other consideration.

Once the diagonal direction of the LPMs is calculated, the tilting angle of the PV surfaces may be set to face the local absorption direction or similar direction. Then there is need to select the gaps between the LPMs. The same simulation can calculate the sun angle for which the shadow that the LPM will cast on the deployment surface is minimal. If maximum energy production is desired, then the next LPM should be located at the end of this shadow, as demonstrated on the right side of FIG. 2, so there is no self-shadow cast on the LPM at that sun angle. This is called the efficient gap, and it is usually in different sizes for different deployment surfaces and locations, as demonstrated by the different-sized gaps 305, 209 and 306 in FIG. 3.

It is also possible to set the desired gaps to be larger than the efficient gap by 10%, 20%, 30% or any other percentage in order to reduce the cost of the system, for example in cases where there is a limit on selling power to the grid, or the consumption is relatively small.

It is also possible to change the optimal tilt angle for various reasons, one of which is to change it to a steeper one in order to enable better water drainage or snow removal.

Daily shading can also impact the diagonal angle directly, and not only impact the calculation of the local absorption direction. As an example, placing the LPMs 408 along the shading lines due to a nearby building or other obstacle 338 can minimize loss of power during times where some of the LPMs are shaded 339, as seen in FIG. 6, provided there is a bypass solution between the LPMs 108 as detailed below.

Any combination of the above considerations and others can be used to set the desired diagonal angle and the tilting angle of the PV surface.

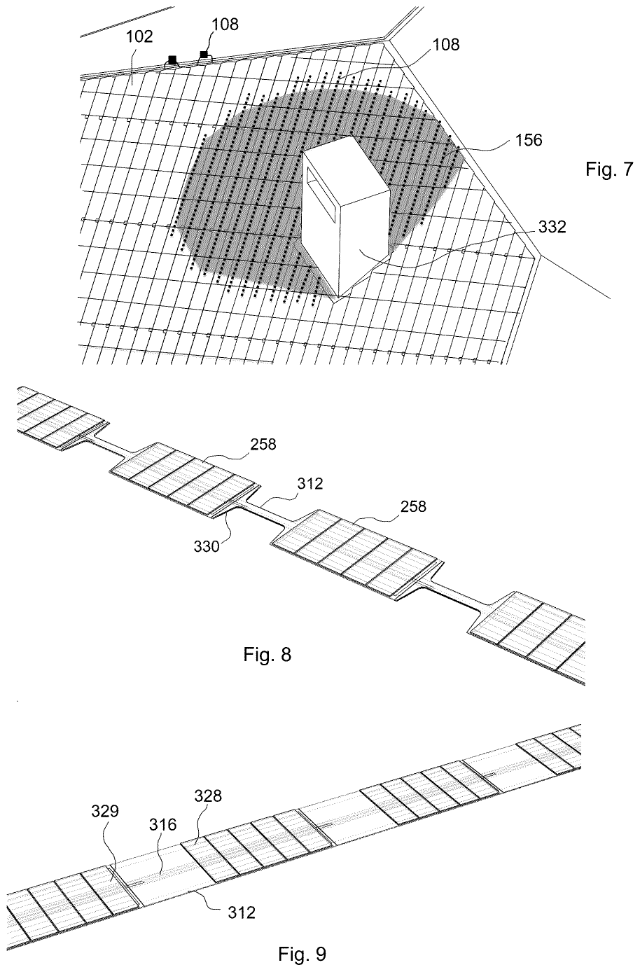

Another way to mitigate daily shading is by implementing a bypass diode for each PV cell (or each few PV cells) in the shaded area during manufacturing or assembly, as seen in FIG. 7. One example of a way to incorporate the diode over each PV cell is detailed in the '727 application. In FIG. 7, one can see the high resolution of the bypass diodes 108 in the parts of the array of LPMs where the LPMs 408 are within the area of the daily shading near the chimney 332. In all other parts of the roof a bypass diode 108 or any other bypass solution is implemented for larger groups of PV cells 102 only. Each LPM is thus manufactured with a density of bypass diodes that match the need of its location on the deployment surface.

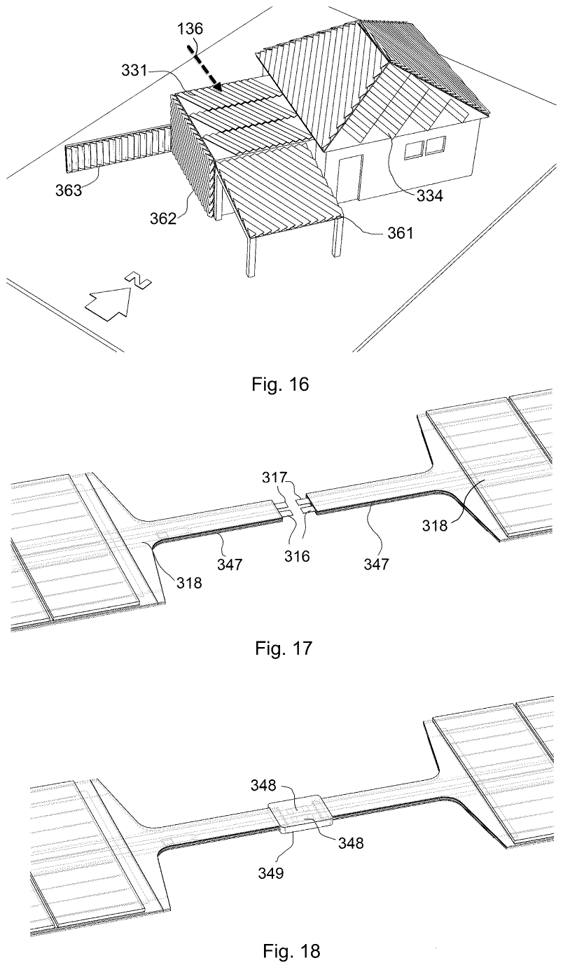

If a cartridge of LPMs is used (i.e. LPMs of the same size connected by integral connectors as detailed immediately below), then the diagonal angle can be slightly changed to better cover a roof with fixed size LPMs, as seen later below in FIG. 16.

### II. Integral Connectors

Referring to FIGS. 8-21, some types of sealed PV modules, PV cell strips and the LPMs can be manufactured as “off the shelf” solutions, while others need to be manufactured with customization to fit the specific properties (e.g. size, shape of the deployment surface or any part of it, as well as desired gap between the LPMs, their diagonal and tilting angles. This can be done without many connectors by incorporating integral flexible connectors 312 into the strip of the sealed PV modules or to the PV cell strip 258 in places along the strip where LPMs should be connected with mechanical flexibility, as detailed in FIG. 8.

As is known to those of skill in the art, generally, a PV module is made of a lamination sandwich. The integral flexible connector (also called here an integral connector) can be comprised of the same lamination sandwich as the sealed PV module but without the PV cells and without tiles, and the lamination material in excess at the sides of the integral connectors can be cut out at the cutting lines 330. as seen by comparing FIG. 8 and FIG. 9. FIG. 8 shows the integral connectors in the PV cell strip 258 before cutting out the unneeded lamination material. It includes the main power line 316 to connect the last PV cell before the integral connector 328 with the first PV cell after the integral connector 329. The wires can go through the center of the lamination sandwich or on its side. In order to enable easy folding or bending of the PV cell strip 258 at the location of the integral connector 312, the lamination material at the sides of the integral connectors can be cut off at the cutting lines 330. After the cut, another process of protecting the new edge may be conducted, either by gluing the layers, or by welding, or by any other means or process. The main power line 316 between the PV cell strips can be comprised of the electrical conducting wires that collect the electrons from the PV cell, so it may be a continuation of the front conduction wires of the PV cells before the integral connector and continuing as the back-conduction wires of the PV cell after the integral connector.

Referring to FIG. 9, the integral connectors may include more than one electrical line. In particular, there is an option to deploy bypass diodes in these integral connectors (or any other bypass), by deploying them on a bypass line 318. FIG. 10 shows an integral connector which includes a die diode 261, the bypass line 318 and the main power line 316 and possibly a reverse polarity line 317 that enable closing the electrical circle more efficiently when there is a need to connect to an optimizer or micro-inverter or inverter. Control lines can also be inserted here in case a FET is used instead of a diode.

FIG. 11 shows an exploded view of a possible lamination sandwich that can support such integral connectors. The collection lines 319 of the PV cells 102 are connected to the collection busbar 320 which is connected to the main power line 316 and can be bypassed by the bypass line 318 and the DIE bypass diode 261. Those can be wrapped by transparent lamination material such as EVA 154 that can also be used to glue the tiles 224 or other front material like ETFE, as well as by back sheet like PET 225 and side protecting layer like ETFE 270, that can also cover the front and part of the back of the PV cells.

Lamination, as used herein, may refer to hot lamination, cold lamination, welding, gluing, injecting or any other process that seals and protects the PV cells and the electronics, while ensuring optical coupling.

FIG. 12 shows another cross-section view of the PV cell strip 258 that explains how a bypass, such as the bypass diode 261, can be activated in the integral connector and bypass several PV cells 102. In the case when a PV cell doesn't enable the current to flow properly and creates a circuit disconnection, the series connection 321 of the collection lines 319 between the PV cells is replaced by the connection between the bypass line 318 to the main power line 316 through the bypass diode 261 at the relevant integral connector. The PV cells, including the one before the integral connectors 328 and the one after the integral connector 329 are facing the sunlight beam 100. Reference numeral 355 refers to the direction the electrons are flowing. The bypass can also be done with a controlled FET.

There is also an option to add a bypass solution in higher resolution by adding integral connectors in places along the PV cell strip where no folding is required, wherein the integral connectors are only added for the sake of adding a bypass solution, so they can be shorter. In fact, this method enables deploying or implementing bypass diodes at any resolution of PV cells in the PV cell strip. This can be decided according to the shading levels for each lengthened photovoltaic module based on the simulation analysis of the specific deployment surface, as seen before in FIG. 7. There is also an option to deploy a FET instead of (or in addition to) the bypass diode and use it to actively control the bypass when needed.

Integral connectors can also be used to fold an array of LPMs for shipping considerations, for example to fit them to the size of a container or a truck without disconnecting the electrical connection between the LPMs. They can also be used to mitigate different lengthening of the sealed PV module relative to the LPM skeleton when temperature changes.

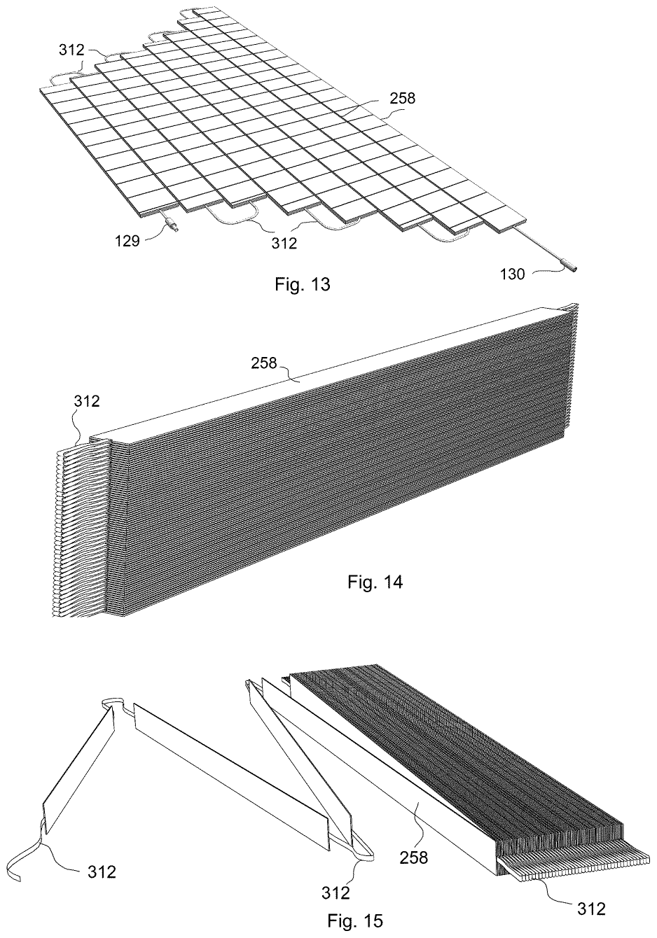

Referring to FIG. 12, when incorporated in customized manufacturing, integral connectors can have different lengths of PV cell strips or sealed PV modules or LPMs or Z3DPs (as defined below) between them to fit a specific shape of a deployment surface, and create a free shape solar pallet (FSSP). FIG. 13 shows an example of a flat FSSP, which is comprised of several PV cell strips 258 electronically connected together by integral connectors 312 with regular connectors (129 male, 130 female) at the input and the output of the FSSP.

The integral connectors also enable manufacturing an off the shelf solution, by manufacturing a cartridge of many sealed PV modules or PV cell strips of the same size connected by integral connectors as seen in FIG. 14 (packed cartridge) and 15 (open cartridge during deployment process). In both figures, the PV cell strips 258 are connected by integral connectors 312 that enable folding them. Each PV cell strip can have one glass cover for the entire strip, or for a portion of it, or a glass tile for each PV cell. In order to enable good coverage of the deployment surface, cartridges can come at different width (e.g. different length of the sealed PV modules).

FIG. 16 shows how a roof slope may be covered with different cartridges 334 that when deployed, looks like lengthened PV panels in different length. There is an option to deploy the LPMs of a cartridge with a diagonal shift 331 in order to better cover some roof types relative to the absorption direction, (e.g. the LPMs can be deployed not parallel to the roof edge), as discussed above in connection with FIG. 7. The coverage is not as perfect as it would be with a fully customized FSSP, but provides much better coverage than regular PV panels. FIG. 16 also demonstrates how a pergola 361, wall 362 and a fence 363 can be covered with regular LPMs.

During assembly, the cartridge can be cut at any integral connector between any two PV cell strips, at the desired length for the specific deployment. Then either a regular connector is attached there or a glued/welded connector between 2 cartridges, as seen in FIG. 17 and FIG. 18. This way, a solar pallet with adjustable length can be built from one cartridge, or from multiple cartridges.

FIG. 17 shows how an integral connector can be cut and the main power line 316, as well as the reverse polarity line 317, if existing, can be exposed by removing some of the lamination material that wrap them. This creates a tail contact 347 to attach a regular connector or connect between two cartridges in different width, as seen in FIG. 18.

FIG. 18 shows how two tail contacts (i.e. the edge of a cartridge or an integral connector that was cut or the edge of an LPM) can be connected by direct soldering the power line and the bypass line and any other line that goes through there (e.g. the reverse polarity line or control lines), or by indirect connection by soldering via an electronic board 348, after which a sealing material 349 can be glued over it to seal the tail connector and protect it from weather issues, mechanical issues creepage and dirt. There are also other options to connect instead of soldering, such as crimping, or screwed or welding or any other method. The connection board can include also a bypass diode, or bypass FET, or any other bypass, as well as measurement sensors and control processor for communication and for managing the bypass smartly. The bypass activation in such a case can be controlled by a computer that is connected to it or locally by control processor or a combination thereof.

The integral connectors can be also manufactured by connecting standalone rows of PV cells connected in series, or sealed PV modules, or PV cell strips or LPMs, through a separate process that connect them without a regular connector, and still enjoy the higher safety and reliability level relative to standard connectors. As an example, the sealed PV modules can be manufactured with tail contacts at the edges which are connected to one another, similar to the process seen in FIG. 17.

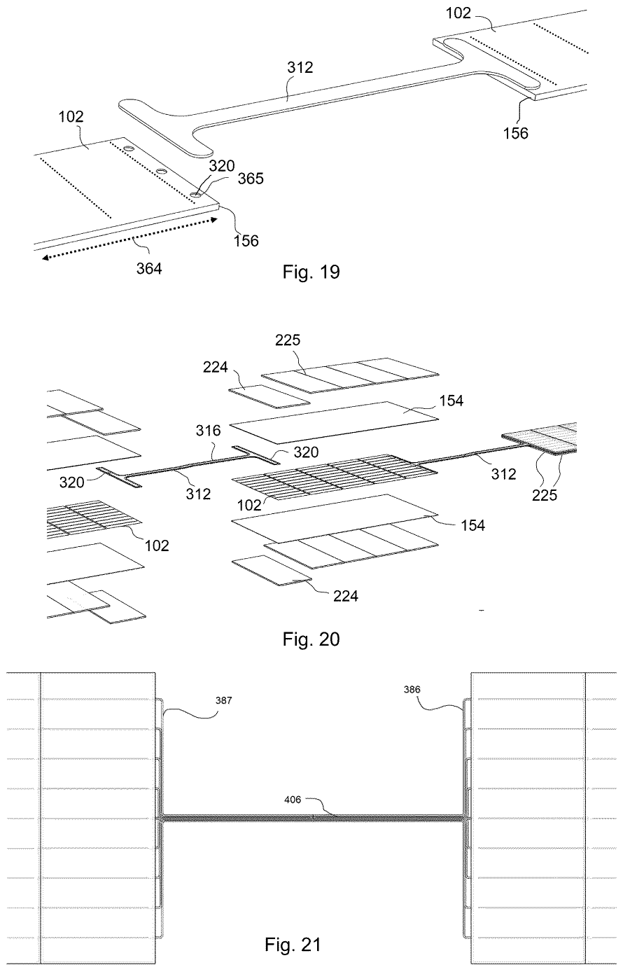

FIG. 19 shows a rear view of another type of integral connector, which is not manufactured as part of the lamination process, but is added at a later manufacturing process after the lamination. The sealed PV module 156 is cut between two PV cells 102 at the desired length 364, and the lamination material is removed in a few points 365 so the collection busbar 320 underneath is exposed. The integral connector 312 is then soldered at these points to the busbar 320 and then the entire connection is sealed with a sealing material such as silicon. The same solution can apply to PV cell strip as well.

There are many other ways to manufacture integral connectors, which are valid provided they are flexible and protect the electrical parts both mechanically and electronically.

There is also an option to deploy an integral connector during manufacturing when the PV cell strip includes glass from both sides of the PV cell, an example for which is described in FIG. 20.

FIG. 20 shows an exploded view of such an integral connector. The integral connector 312 with the isolated main power line 316 is connected to the PV cells 102 prior to lamination, and the transparent tiles 224 are also protecting the collection bar 320 and its connections after lamination with layers of lamination material, such as EVA or POE 154. Sealing silicon 225 may be used to seal between the tiles 224 and at the other edges of the tiles.

The main power line between the PV modules in an integral connector can also be comprised of the grouped electrical conducting wires 406 that are collecting the electrons from the PV cell, so it can be (for example) a continuation of the front conduction wires of the PV cells 386 before the integral connector and continuing as the back-conduction wires of the PV cell 387 after the integral connector, as seen in FIG. 21. The grouped electrical conducting wires 406 can be covered, protected and isolated by the lamination material and by other materials in additional process. This way there is no need to cut the conducting wires and connect them to a busbar in each integral connector.

There is also an option to manufacture a customized cartridge of LPMs in different sizes, in order to fit to a specific roof shape, as seen in FIG. 13, by connecting a different number of PV cells between the integral connectors (e.g. different length of PV cell strips).

### III. Structures of Skeletons—Gamma-Shaped Profiles

An LPM skeleton can be designed in many ways, that will enable mechanically connecting the LPMs at the required angle according to the local absorption direction or any other desired direction and at the desired gap (or distance) between them. Usually the skeleton is designed so it doesn't cast any shadow on the front of PV cells in the relevant sun angles. In case of bifacial PV cells, it is designed so it doesn't cast shadow on either side of the PV cells in the relevant sun angles, or at least in a manner that minimizes the shadow and ensures similar level of shadow and illumination on all PV cells, assuming the PV cells are of the similar size and similar efficiency. Usually, to achieve these requirements, the skeleton is below or behind the sealed PV module.

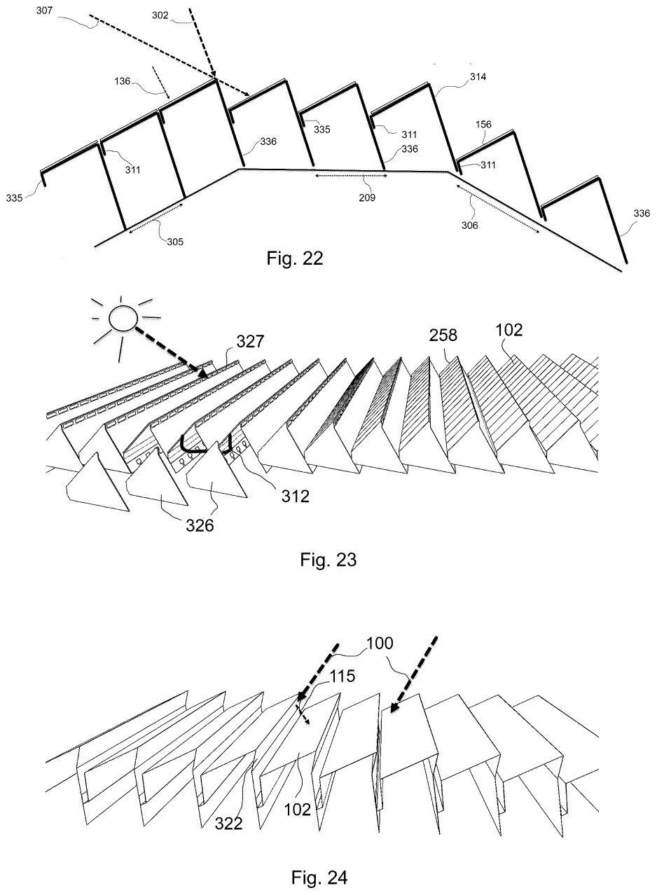

In some of these LPMs, one mechanical connection can set both the angle of which the PV cells are tilted as well as the proper distance between the LPMs for any roof slope, by connecting the LPMs at a specific connection point between the LPMs and at specific angle between them. One example for such LPM skeleton is detailed in FIG. 22 (the gamma-shaped profile). As used in the present disclosure, a “gamma-shaped profile” is a profile shaped like a Greek letter gamma (Γ), with a horizontal support extending at a right angle from a vertical leg.

FIG. 22 demonstrates from a side view how gamma-shaped profiles 314 can be set so the PV cells in the sealed PV modules 156 face the absorption direction 136 or any other desired direction, on different roof-facing directions (south on the left side of the figure, north on the right), by changing the location of the connection points 311 between the short leg 335 of one gamma-shaped profile and the long leg 336 of the next gamma-shaped profile, if the design enables this with long enough legs. This maintains the same angle towards the summer zenith 302, (or any other preferred angle) while changing the gap between the LPMs from the gap on a flat horizontal roof 209 to the adjusted gap on any slope: smaller gap if the roof tilting is facing the desired direction 305 more than a flat roof and larger if the roof tilts further away from it (as indicated by arrow 306), so all photons in all seasons are colliding with the PV surface and there is no wasted PV surface that is never exposed to the sun.

FIG. 23 shows an array of gamma-shaped profiles in perspective view. The LPM skeleton, made of aluminum or plastic or any other resilient material, is covered with a PV cell strip 258 or sealed PV module. A side cover 326 may cover the wires and protect them, and in some versions can include a busbar in case the LPMs are not connected by integral connectors (as discussed in connection with FIGS. 8-21). Possible ventilation holes 327 let hot air out in order to reduce the temperature of the PV cells 102.

The gamma-shaped profile can have holes in it for water drainage or no holes except for ventilation purposes on tilted roofs for creating a smooth gutter for rain, hail and snow. In the case of large drainage holes, this is very useful as an agrivoltaic solution, since it enables rain to irrigate all the land equally that otherwise will partially stay dry under regular size PV panels.

The gamma-shaped profile skeleton can also be made of mirror level polished aluminum and a special geometric design, that enables photons to be reflected onto the PV cells in cases where the sun angle causes some of the photons to miss the PV surface, as seen in FIG. 24.

FIG. 24 shows a gamma-shaped profile with an extra tilt in the structure 322 which is acting as a mirror which reflects 115 sunlight beam 100 in some sun angles to the PV cells 102, while maintaining the same level of illumination for all LPMs to avoid electric mismatch. Here too, all the PV cells are receiving the same amount of extra photons so no PV cell is acting as a power bottleneck.. Blank units may be added in the edges as reflectors to provide reflection photons to the LPM when the sunlight is coming partially from the side, and not from the perfect south. The mirror effect can be achieved with any other material, such as reflective paint or a reflective stick.

### IV. Free-shaped Solar Pallets Based on Gamma-Shaped Profiles

As mentioned before, in order to fully cover triangular roofs, there is a need for solar pallets which are not square, i.e. free shaped solar pallet (FSSP). FSSP can be created by connecting any LPM together, each of them at the length required for building the desired shape, and they can be connected to a base frame in order to strengthen the FSSP and keep it at the same shape when lifted. The base frame can include reinforcement beams, sometime called base units. A plurality of base units can be connected along, behind or below (in the case of bifacial LPM) the lengthwise dimension of said LPMs for positioning them at a selected direction without casting shadow on them.

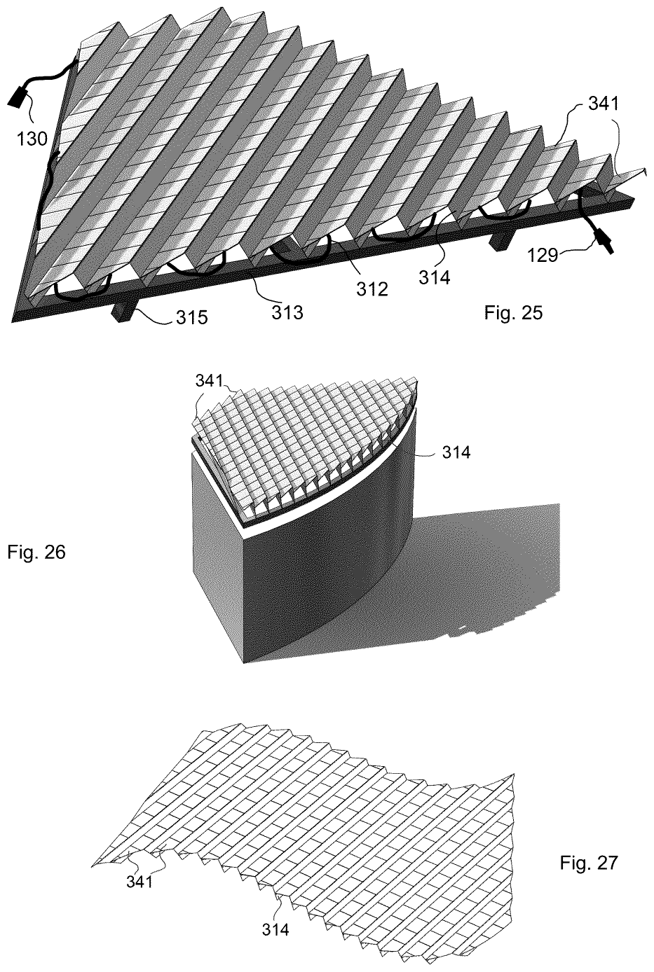

FIG. 25 shows an example of a FSSP built from gamma-shaped profiles 314. The gamma-shaped profiles are mechanically connected to each other and can also be connected to a base frame 313 for increased strength, possibly with frame legs 315 that can be connected to a heavy weight for stabilization on a horizontal roof. Such a base frame is mechanically connected below (or behind in case of wall mounting) the LPMs in order not to cast shadow on them in the relevant sun angles. There is an option to add blank or dummy cells 341 without PV material at the edges of the LPMs just to smooth the shape of the FSSP to match it with the edges of the deployment surface for aesthetic or drainage reasons. The blank cells may be cut to create any desired shape. These blank cells can also contribute reflection of sunlight on the edges to avoid current bottlenecks, as explained below, so that the amount of solar illumination on the PV cells is similar in all self-shading conditions.

FIG. 26 shows an example of a FSSP with a rounded shape, which is comprised from gamma-shaped profiles 314 in different lengths and blank cells 341 that are be added to improve the shape of the FSSP and match it with the roof shape.

In FSSP, unlike in standard PV panels, it is possible that at least one row of PV cells (such as in sealed PV module, PV cell strip or LPM) is different in length than another row of PV cells. FSSP can be manufactured with a customization to fit a specific roof, or it can be supplied as cartridge of LPMs at the same length with integral connectors between them, as described before.

There is also an option to provide a cartridge of PV cells strips or sealed PV modules separately from the LPM skeleton.

Each FSSP needs to have at least two regular electrical connectors, input and output.

FIG. 27 shows a FSSP with no frame, whereas the connection between the gamma-shaped profiles 314 is what maintains the shape of the FSSP. There is an option to add blank cells 341 without PV material as explained before.

### V. Deployment

### A. Deployment on Roof Slope

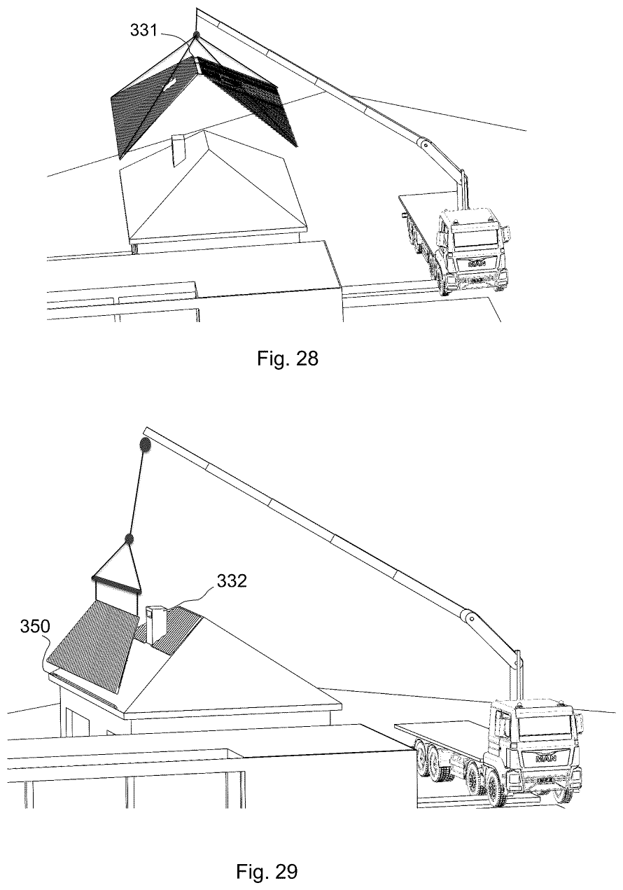

The FSSP can come in the size of a complete roof slope, that can be fully tested electrically before shipping, including with combination of optimizers or micro-inverters. Smaller size FSSPs can also be tested the same way. In this case, the whole roof slope deployment may have only two regular connectors. If two opposite slopes of a roof are being covered, such as east and west slopes, they can be mechanically connected 331 at the rooftop to balance the weight in both sides, in a saddle-like concept, as seen in FIG. 28.

A deployment on a roof slope can be divided into a set of FSSPs in many sizes and shapes. One of the possible considerations can be to divide it into small enough FSSPs to be carried by hand to and on the roof (i.e. without a crane). Another possible consideration can be to split the FSSPs around objects on the roof, such as a chimney 332 or an antenna, as seen in FIG. 29. There is an option to connect a base beam 350 to the roof beams before the installation in order to support the installation of the FSSP, after which it can remain as part of the connection points of the FSSP to the roof.

Another possible consideration can be to have separate FSSPs for shaded areas vs. non-shaded areas. Another possible consideration is to limit the size of the FSSP based on the maximum allowable or required voltage required for a string. Another possible consideration is to minimize the number of integral connectors, and thus to use LPMs which are as long as possible.

Maintenance solutions for deployment solutions are discussed infra in connection with FIG. 40.

### B. Deployment on a Rubber Pad

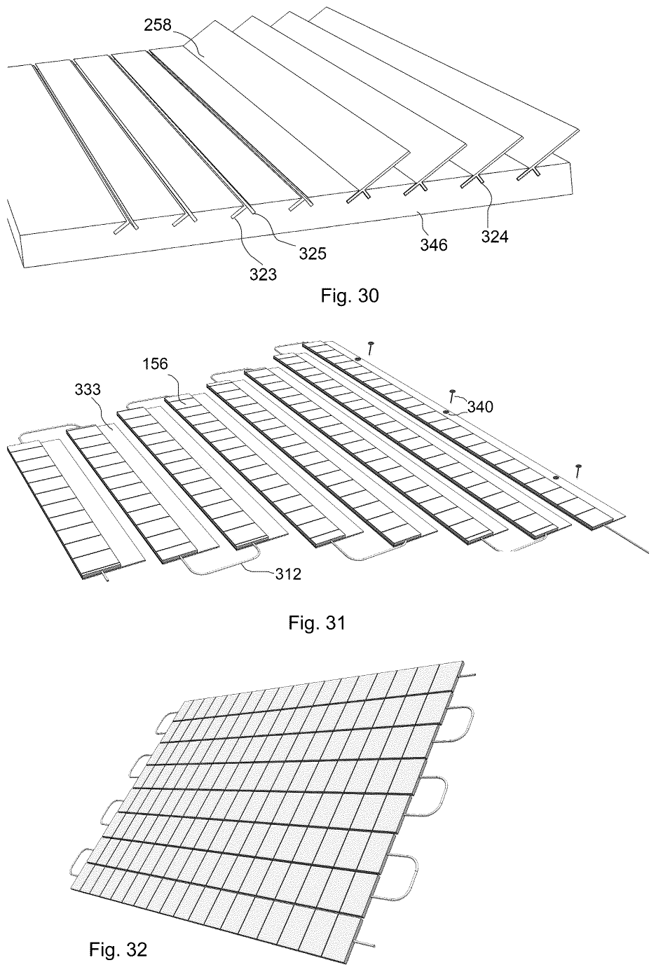

Another option to create FSSP is by using a rubber pad 346 as detailed in FIG. 30: slots 323 in the pad are prepared in an angle and distance required for the LPMs to be deployed. The LPM in this case is the PV cell strip 258 which is rigid and has a supporting leg 324 that is deployed into the supporting slot 325. The rubber pad can be replaced with a rubber net to reduce cost of material, or plastic or any other desired material.

### C. Roof Shingles

Referring to FIG. 31, a sealed PV module can also be the base for a roof shingles solution, which not only provides higher efficiency solar power (relative to a thin film for example), but also acts as a roofing solution, by extending the lamination on one side 333 of the sealed PV module 156, creating an additional strip 333, that is nailed to the roof 340 like regular shingles. The additional strip 333 can be comprised of other materials, not necessarily part of the lamination material, and then glued to the sealed PV module. The sealed PV modules can be connected by integral connectors 312.

FIG. 32 shows such a roofing solution with similar size sealed PV modules after assembly.

### D. L-shaped Profile With Adjustable Gaps Between Modules

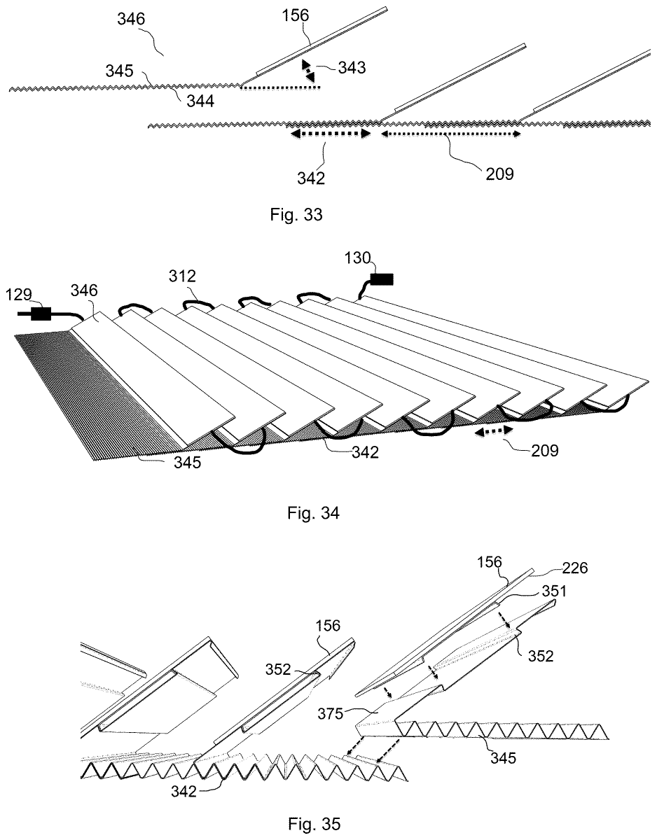

FIG. 33 shows another option for an L-shaped profile 346 (which is an LPM in the shape of a bent L), with a mechanism to set a different gap 209 between the L profiles according to one or more of the measured parameters of the deployment surface, such as location, slope azimuth and steepness of the deployment surface. The bottom part 344 of the L-shaped profile incorporates adjustment strips 345 that set the gap between two adjacent L profiles when connecting them together according to the overlapping part 342. The mechanical connection can be done in many ways, such as welding, gluing or screwing. The angle 343 between sealed PV module 156 and the bottom part 344 can be set during manufacturing, assembly or deployment. The structure of the skeleton of the L profile enables inherent flexibility at the point of the angle 343 to help mitigate the impact of hail.

FIG. 34 shows an FSSP comprised of L-shaped profiles 346 connected in series by integral connectors 312. Regular connectors 129, 130 are the electrical input and output of the FSSP. The adjustment strips 345 set the gap 209 between the L profiles 346 according to their overlapping part 342.

FIG. 35 shows another view of the L-shaped profile 346 that demonstrates how a snap strip 351 is connected to the back sheet 226 of the sealed PV module 156 and can be quickly inserted to the snap rail 352 in the L-shaped profile 346 during deployment or assembly. This connection mechanism enables accommodating different lengthening of the sealed PV module 156 in high temperature relative to the lengthening of the skeleton of the L-shaped profile 375. It is possible to use a PV cell strip instead of the sealed PV module 156 in such a solution. Other solutions can be used to connect the sealed PV module 156 to the LPM skeleton in such an accommodating way for temperature changes, as well as for setting the gap between the LPMs as needed. The gap adjustment strips 345 set the gap between the LPMs.

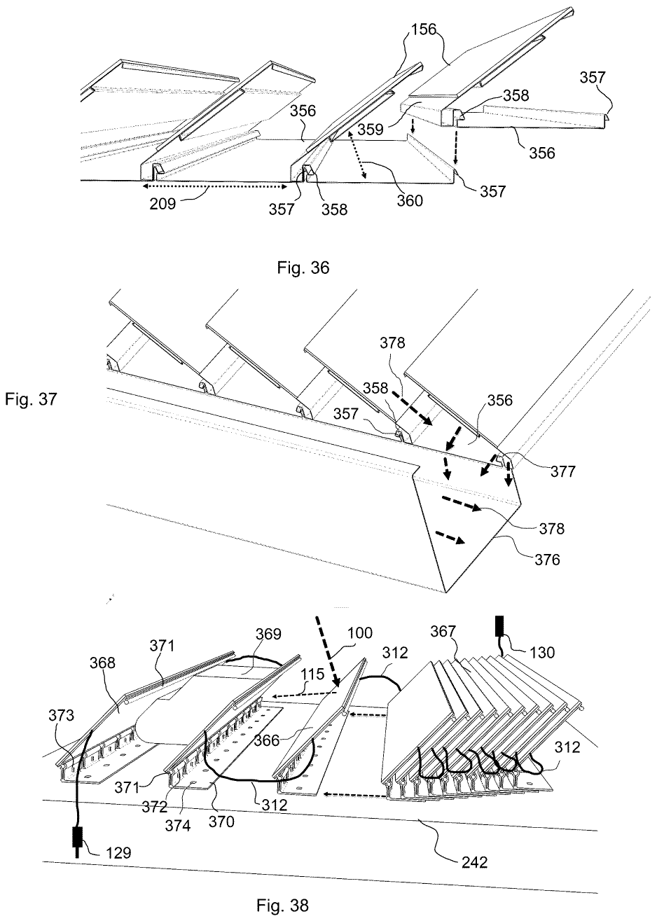

Referring to FIG. 36, the array of LPMs can also be designed as a roofing solution, instead of adding it to existing roofing, like shingles, roof tiles or metal roofing. Unlike regular solar roofing solutions, this solution enables setting the PV cell strips in a desired direction that is different than the direction to which the roof slope is facing by at least 1 degree, sometimes by 5 or 10 degrees or more. The skeleton of this roofing LPM 356 may be built from many materials, such as metal or plastic. The LPMs utilize the regular shape of metal roofing (seams) and may come with roofing snap-lock elements (357 male, 358 female), and includes additional wing 359 on which the sealed PV module 156 is attached (or the PV cell strip), so there are no open holes in the LPMs that can cause water leak. The angle towards the sealed PV module 156 is facing is dependent on the diagonal deployment angle of the roofing LPM 356, as well as on the wing LPM 359 tilt angle 360, that can be set relative to the bottom LPM skeleton during manufacturing, assembly or deployment, if the wing LPM 359 is a separate part. The distance between LPMs 209 in this example is the width of the roofing LPM skeleton and is set during its manufacturing process. The LPMs are mounted so that any water poured on them will flow to a gutter or outside of the roof, except that water poured on the overlapping part of two LPMs will flow to one of said LPMs. Deploying the sealed PV module or the PV cell strip into the LPM skeleton can be done during manufacturing, assembly or deployment, and it can also be connected to the LPM skeletons through a rail that accommodates different lengthening during temperature changes, as was explained in connection with FIG. 35.

Advantages of the mounting solutions described herein (including the Gamma-shaped, L-shaped, and roof-shingles) include that they do not incorporate mounting elements or other supports that cast shadows on the PV modules. All of the supports are underneath the surface of the sealed PV modules. This is true regardless of the angle of the incoming sun.

FIG. 37 shows how roofing LPMs 356 may be deployed in a way that causes all the rain to flow into the gutter 376. Some of the rain that falls on the area 377 where the LPMs overlap will flow 378 to the next LPM before arriving to the gutter 376.

### E. Special Implementations of Base Units for Bifacial Profiles

FIG. 38 shows another type of a bifacial LPM, including bifacial PV cells 366, in which reflections 115 of the sunlight beam 100 from one LPM can collide with the next LPM and increase the generated power. FIG. 38 illustrates flat bifacial profiles; implementations with three-dimensional bifacial profiles will be discussed infra.

This bifacial LPM has a dedicated base unit 370 that (similar to others described herein) is connected below or behind the LPM so it will not cast any shadow on it in any sun angle both from the front side of the LPM as well as from the back side of the LPM in case of a bifacial LPM. This constitutes an improvement over conventional support structures, which often include support beams extending alongside or even above the solar panels, which may cast shadows on the PV cells at certain times and from certain angles. Such support beams often cast shadows on the back of bifacial PV panels and hurt their bifacial performance. [The shadow casting requirement may alternatively be achieved by using transparent material for the skeleton, either alone or in combination with the smart design elements shown herein.]

The base unit is connected to the deployment surface 242 through screw holes 374 or by glue or by any other way. The LPM may have two axle bars 371, one on each side, built into it or mechanically connected to the LPM on its transparent back side, so it can be connected to the axle rail 372 in two ways. This enables the LPM cartridge to be manufactured in one process, although each LPM has an opposite deployment direction than the LPM next to it. The angle of the LPM may be fixed by strengthening screws 373 that tighten the axle bar inside the axle rail 372. These bifacial LPMs 368 are laminated in transparent materials from both sides, and can arrive as a packed cartridge 367 to the deployment surface, connected by integral connectors 312, and are unpacked and mounted to the deployment surface one by one. This can be done by using one or more spacers 369 that sets all the LPMs at the desired (same) distance from each other and at the desired (same) angle, and is removed after the assembly or deployment. Male connector 129 and female connector 130 may be connected at the beginning and end of the cartridge.

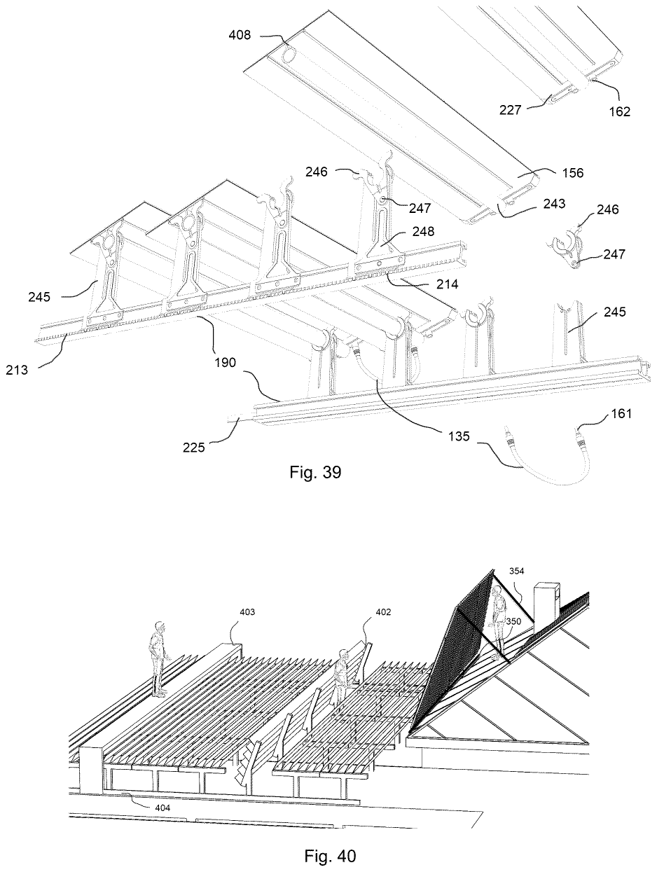

FIG. 39 shows a bottom isometric cross-section of a solution based on different LPMs. The base units 190 are attached to the deployment surface and are holding the leg units 245 in which a quick connection unit 246 is plugged in and the LPMs 408 are inserted therein. The LPMs are comprised of rotation axle unit 243 and a sealed PV module 156, which are connected. The quick connection unit 246 is connected by a tilting axis 247 to a tilting arm 248 which is connected to the tilting rod 255. The tilting rod 225 is moving within the leg units 245 and the base units 190 back and forth in order to tilt the LPMs 408. This is done by tilting the tilting arm 248, which tilts the quick connection unit 246, which tilts the LPMs 408. The electric wire 135 with its two connectors 161 connects two flat connectors 227 in two adjacent LPMs 408 in order to create the series connection. The sealed PV module 156 can be covered with ETFE or with glass tiles for protection. In order to maintain the self-shading solution valid, each of the tilting arms 248 should have the same distance between them when connected to the tilting rod 255, but this distance can change based on the roof slope direction and steepness, the location latitude and other parameters, in order to set the system in the most cost-effective way in terms of cost per watt. The distance between the leg units 245 connected to the base units 190 should also be the same for all leg units. Positioning pins 214 are inserted into the positioning holes 213 to set the gap (or distance) between the LPMs. This solution also demonstrates a design for an easy way to replace a faulty module of the flat profile by pulling out the electrical connectors 161, removing the flat profile 243 from the quick connection units 246 then inserting a replacement LPM 408 instead and plugging it with the connectors 161. The view of the base unit 190 that is in the foreground of FIG. 39 details the system's components inside the base 190 and inside the leg units 245, as well as how they connect.

### V. Additional Strategies for Deployment and Maintenance

Deployment process of PV panels on a roof has safety issues since it is very challenging to stay stable with a heavy, 2 square meter panel, especially on tilted roofs, especially during windy times. Using a crane to place each PV panel is awkward, time consuming and expensive due to their quantities. However, if the entire roof slope is comprised of one large FSSP, or divided to a few pieces only, using a crane for lifting and placing each of them becomes a viable option, as seen before in FIG. 29.

FIG. 40 shows how an FSSP can be lifted for maintenance purposes. The base beam 350 is built as a lifting axle, which can be done manually if the FSSP is light weighted, with possible stabilizing rods to hold it. In case of a heavy FSSP, pistons 354 can be added. Another way to mitigate the weight is by using torsion spring at the axle. In case of a flat horizontal roof, there is also an option for a lifting axle 402 and maintenance bridge 403 that can move on a rail for a maintenance bridge 404.

### VI. V-Shaped Three-Dimensional Profiles

A three-dimensional profile (3DP) is a lengthened PV module comprised of 3-dimensional PV (3D PV) units which are connected in series along the lengthened dimension of the 3DP. Each cross section (or each 3D PV unit) is comprised of 2 or more PV cells or PV surfaces connected in parallel that are facing more than one direction, or one PV surface that is designed to face more than one direction or a combination of them. 3D PV units can be in any 3-dimensional shape, such as a V shape, at any internal angle between the V sides, other polygonal shapes, or U shape or arch shape or any combination of them. 3DP is comprised of at least two 3D PV units connected in series and facing similar direction, but can be comprised of three, four or any other number of 3D PV units. 3DPs can be mounted on any roof in any direction, any diagonal and any tilting angle, but in most cases, the 3DPs will be deployed in a different tilting angle than the deployment surface by at least one or two degrees.

### A. Manufacture

One example of a three-dimensional PV structure is a V-shaped structure. The V-shaped profile is more energetically efficient than a photovoltaic panel array covering the same area and consisting of flat panels. In addition, when the sides of the V face east-west, this configuration produces more energy during the morning and evening hours compared to panels facing south.

Referring to FIG. 41, V-shaped profiles may be manufactured with glass lamination while the glass is already in the required V-shape. FIG. 41 shows an exploded view of an exemplary V-shaped profile manufactured with a top cover, which may be glass, already in the form of V-shaped 394. Two separate, flat, photovoltaic cells 102 are combined to create a 3D PV unit 407. The PV cells 102 are capsulated between layers of lamination material 154 and the V-shaped glass 394 from both sides. In order to overcome self-shadow challenges, the two opposing faces of each 3D PV unit in a V-shaped profile are connected in parallel. The connection can be between each PV cell directly with the other PV cell in each 3D PV unit, or in case a V-shaped profile is built from two separate flat lengthened profile modules, then the modules on the two sides of each V-shaped profile are connected in parallel at their edges. Alternatively, one face of all the V-shaped 3D PV units of the 3DPs array can be connected together in series in one string, which is connected in parallel to another string that includes all the second face of all the V-shaped 3D PV units in the 3DPs array. The top cover may be made from any firm transparent material and any 3-dimensional shape.

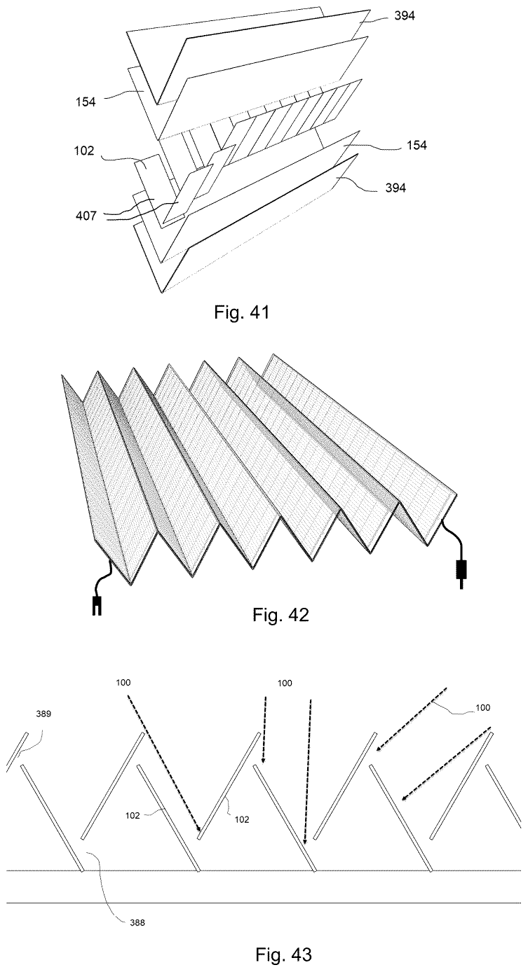

FIG. 42 depicts a V-shaped panel. The panel may be manufactured according to the process depicted in FIG. 41, by connecting 3D profiles, or by using one glass and one back sheet to laminate multiple 3DPs in one process.

The two opposing faces of the V-shaped 3DP can be of different sizes, to accommodate different directions and tilting angles of a roof slope.

### B. Solutions for Dirt Accumulation

On tilted roofs, V-shaped 3DPs can be cleaned easily as they are acting a drain for rain or splashed water if mounted in a proper angle.

However, placing such a V shaped 3DPs flat on a flat, horizontal deployment surface may cause a strong reflection in the winter in areas farther away from the equator, and thus reduce the power it generates. It may also cause dirt to accumulate and reduce the power generated by the PV modules. A way to solve the dirt problem is to design the V shape 3DP from 2 separate flat LPMs, so there is a gap between the two sides of the V shape 3DP as described in FIG. 43.

FIG. 43 shows a schematic side view of an example of how a V shape 3DP can be designed with a gap 388 on the bottom of the V to enable dirt to wash out. This can also be done by using two, separate flat LPMs and position them in a shape of V and connecting them in parallel. The PV cell 102 on the right side of the V shape 3DP is positioned with a shift relative to the position of the PV cell on the left side of the V shape 3DP in such a way that creates a gap between them. The sunlight beams 100 can still be utilized effectively in all seasons and most of the daytime, and the top gap 389 is used to let hot air out and cool the V shape 3DP.

In any design of 3DP, the two walls of the V shape 3DP can be of different sizes, to accommodate different directions of a roof slope.

### C. Zigzag-Shaped 3D Modules Incorporating V-shaped Profiles

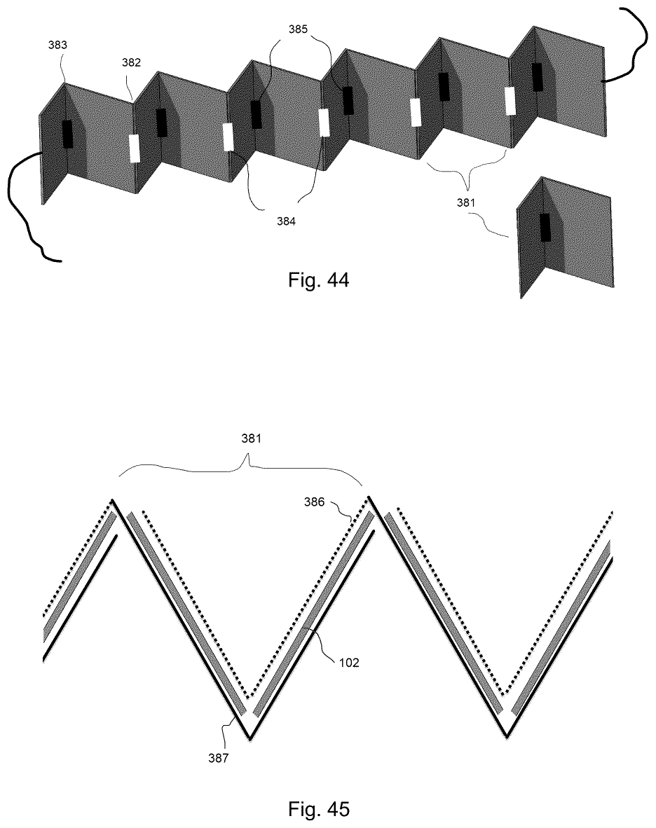

Referring to FIG. 44, a zigzag-shaped three-dimensional profile LPM (also referred to herein as Z3DP) is illustrated. The Z3DP includes multiple V-shaped units.

A way to solve both issues mentioned above (reflection and cleanliness) is by creating a design that can be tilted on an horizontal deployment surface such as the zigzag shape 3DP, in which each 3D PV unit is comprised of 2 PV cells connected in parallel, and the V shaped 3D PV units (V units) are connected in series to one another, in a way they are creating a zigzag shape, (Z3DP) as detailed in FIG. 44. The zigzag-shaped profile inherently addresses both cleaning of the devices below and minimizing reflection.

FIG. 44 shows a single Z3DP comprised of three-dimensional PV units 381 in a V-shape. Between the V-shaped units, adjacent cells are connected in series (shown with reference numeral 382), while inside the V-shape, the PV cells which oppose each other are connected in parallel (shown with reference numeral 384). In contrast to the embodiment of FIG. 42, in which the electrically connected V-units are connected one after another, to form a gutter, in FIG. 44 the electrically connected V units are connected beside one another, creating a zigzag. The physical connection between the V units 382 and between the two photovoltaic cells 383 in each unit may be fixed, or may be flexible to accommodate different V angles.

FIG. 45 shows a cross-section view of an example how the PV cells 102 within such Z3DP can be electrically connected in parallel within the V unit, and electrically connected in series between the V units. Inside each V unit 381 the front conduction wires of the PV cells 386 (i.e. on the side of the PV cells that is designed to face the sun) are connected together (front to front), and the back-conduction wires of the PV cell 387 are also connected (back to back). Between the V units 381, the back-conduction wires 387 of the V unit on the right are connected to the front conduction wires 386 of the next V unit on the left in a series connection, and so on.

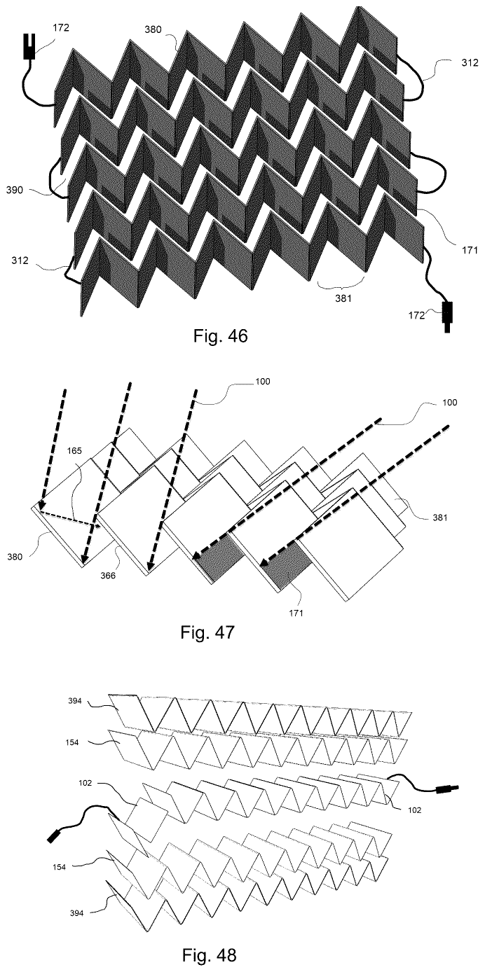

FIG. 46 shows an example of an array of Z3DPs 380, all positioned in parallel, facing similar direction and connected in series by integral connectors 312 (discussed above in connection with FIGS. 8-12). This example shows how the Z3DPs can be geometrically deployed as an FSSP. Two electrical connectors 172 may be connected at the two ends of the FSSP, one for the plus connection and one for the minus connection. The Z3DPs in such an array can be set in any tilting angle and with any gap between them. The smaller is the tilting angle, the system can be less expensive, since fewer PV cells are required to cover the deployment surface.

Preferably, the gaps between the Z3DP modules are set as described earlier for gap setting according to the summer zenith (as discussed in connection with FIG. 2, by using the definition of facing for 3D units) so that the gap between the Z3DPs 390 is set for optimized energy production per area. Any other desired gap may also be used.

The arrays of Z3DPs have similar gap or distance between them (can be up to 5% or 10% gap difference and still perform well) to ensure similar level of light and self-shadow (171) to all the V units 381 except for extra illumination on the edges and on the first Z3DP module (the module whose V units are not facing another Z3DP module), which doesn't hurt the performance of the string, and can be mitigated by dummy V units on the edges and dummy Z3DP in the front..

This array fits a flat deployment surface in any tilting angle. However, Z3DPs can be mounted on a curved surface with different gaps at a similar method described in the '727 application for deployment on a curved surface, achieving the same result of similar shadow levels. [In this context, self-shadow includes both the shadow cast by one Z3DP on another as well as the internal shadow of each Z3DP unit on itself (inside the V shape). Such FSSP can be comprised of Z3DPs of different length.

FIG. 47 shows how the same shadow occurs on all the V units 381, when the sunlight beam 100 in the winter (on the right) arrives at a low angle, so all V units receive similar level of light and experience similar self-shadow 171, so each V unit 381 can generate the same level of power and none of them becomes a bottleneck for the current of the string. The sunlight beams 100 on the left arrive from a higher sun angle (e.g. midday in summer) so no shadow is cast on the V units 381. This is only one example for an array of similar units that cast similar shadow on one another, thus none of them becomes a bottleneck for the current.

In case the Z3DP is comprised of bifacial PV cells 366, some photons are reflected from one face of the V unit to its other face, and other reflected photons 165 from one Z3DP 380 are reflected to the adjacent Z3DP from the back side (back reflection), providing again the same level of light from the back to each V unit, so no V unit is acting as a bottleneck for the string. The back reflection might be lower at the edges of the Z3DPs when the sun is not directly in front of the Z3DPs, which might create a bottleneck for the current and power generation, so there is an option to add blank units at the edges, that will act only as reflectors, and will not be connected electrically. The last LPM also doesn't get back reflection from a Z3DP behind it, but gets more background radiation, so there is an option to place a blank Z3DP as well, last in the array, that will not be electronically connected and will act as a mirror for back reflection if needed. There is also an option to add blank Z3DP in the front of the array as well to reduce the illumination on the first Z3DP to match the illumination of the other Z3DPs in the array. In the summer in many latitudes during sunrise and sunset the sun shines on the PV modules from a northern angle. In these times the back side of bifacial Z3DPs will receive direct light while the front side will receive only reflections.

There are many ways to manufacture these types of Z3DP solutions, one of which is to use tiles 224 as detailed above (FIG. 11, for example), and to use a structure that positions them in the right angle. However, the string of the PV cells needs to be electrically connected differently than described before, as detailed in FIG. 43.

One method to manufacture these PV cell strips (i.e. PV cells in a row) for Z3DPs, as an example, can be by programming a stringer machine to flip between front and back wiring of the PV cells every two PV cells instead of every single PV cell as it is done today. This will create a strip of PV cells, where each pair PV cell that are comprising a V shape are connected in parallel as if they were one larger cell, (both fronts of the PV cells in each PV unit are connected and both backs of PV cells are connected, i.e. parallel connection), while between the pairs of PV cells the connection is from the back of one pair of PV cells to the front of the next pair of PV cells (i.e. connected in series). These connections can be implemented before positioning the strip of PV cells in a V shape, and then setting them at a zigzag shape before or after the lamination. For more complex shapes of 3D PV units, the flipping can be done every three PV cells, four PV cells and any other number of a group of PV cells.

The lamination of such Z3DP solution can be of any relevant material, with or without a glass cover, and can also be done by spraying PV material on a zigzag structure or by volatilization or evaporation or bathing it in PV material or any other method.

FIG. 48 shows an optional structure/method for lamination: the PV cells 102 are laminated between transparent sealing material such as EVA or POE 154 and top cover (such as glass) which is already in 3-dimensional structure, e.g. bent to or manufactured in a zigzag structure 394. Such lamination can be done also with any type of transparent material as a top cover instead of glass in the front, and any type of material in the back as a back sheet which can come at a zigzag shape or it can be bent to this shape during lamination, and can optionally be transparent for bifacial purposes. Lamination can be cold lamination, hot lamination, gluing, injection or any other method that will generate proper optical coupling on the front side and on the back side. It is also possible to laminate the PV module with a flat top cover and bend it after the lamination.

The Z3DP can include more than one PV cell in a cross section, as long as these PV cells are connected in parallel

A Z3DP can be applied also to tilted deployment surface in any angle, from flat horizontal deployment surface and up to a vertical angle of deployment surface (e.g. a wall or a fence.

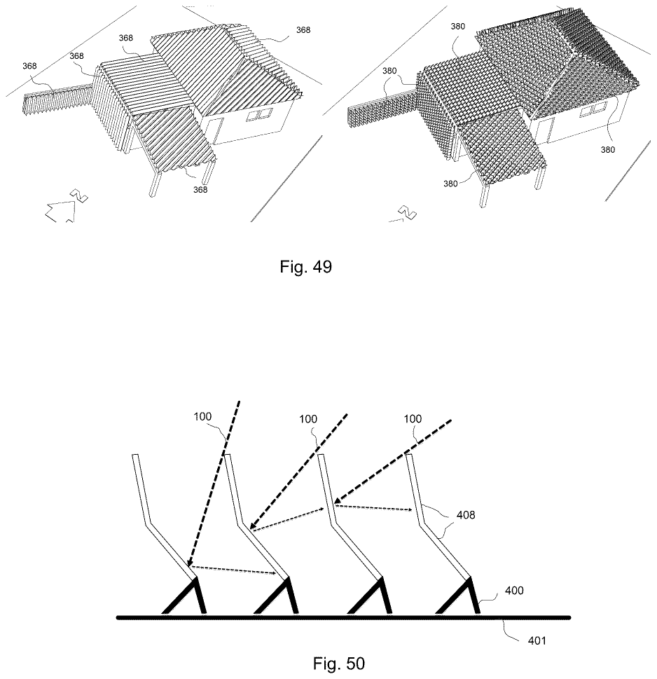

FIG. 49 illustrates a lengthened photovoltaic module 368 on the left house (identical to the one depicted in FIG. 16), and a Z3DP photovoltaic module 380 on the right side, arranged on the same structure, including a slanted roof, wall, fence, and pergola.

Referring to FIG. 50, the zigzag and V Shapes, as well as the flat profiles can be designed in any similar shape, like a U shape profile from a flexible PV cell or thin film or perovskite, or a V with different angle in the deeper part of the V shape than the other part of the V. FIG. 50 depicts one specialized shape-flat LPMs with more than one angle: The flat LPM 408 is illustrated from a side view, mounted on its skeleton 400 that is mounted on a base frame 401, and is comprised of two parts, each at a different angle, to improve the reflection of the sunlight beam 100. See also the curved profile discussed infra at FIG. 57.

### D. String Connections for Z3DP and LPM

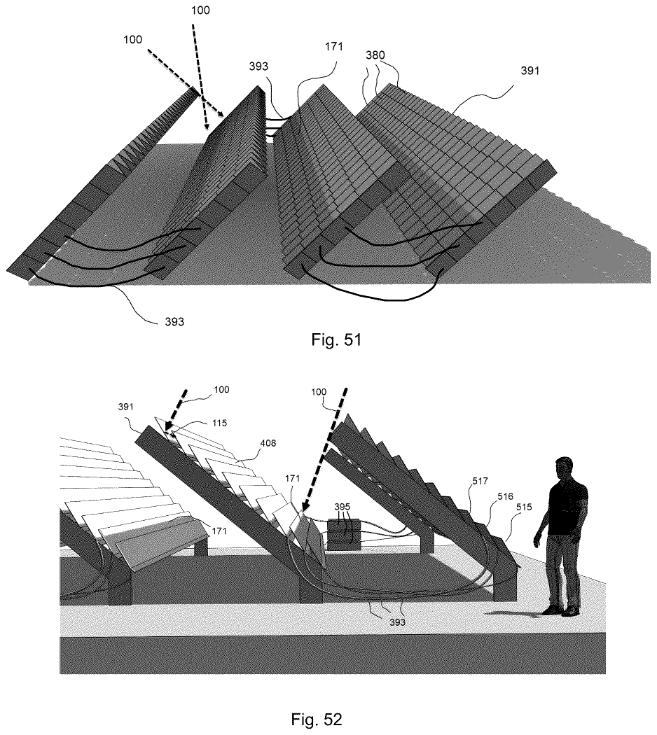

FIG. 51 shows how a set of Z3DPs 380 may be arranged in a continuous setting, where the PV cells in each Z3DP are positioned in continuation of the PV cells of the Z3DP adjacent to it, forming a continuous V drain shape of similar 3D PV panels (V table). All Z3DPs in the same height from all the different V tables are connected in series with connection wires 393 to create a separate string, so mutual shadow within the V table 171 only impacts those shadowed strings to the extent they are shadowed, and not the entire array. Such architecture provides immunity to the self-shading (sometimes called in here mutual shading and meaning the shadow that is cast by one LPM on another or by the LPM on itself, in case of an 3D LPM) and enables condensing the V tables without losing power due to electric mismatch except for the shadowed rows to the extent they are shadowed.

Such tables may be set in any angle relative to the deployment surface. In the special case that they are horizontal, the connections 393 can be from one Z3DP (in its entirety) to the next, since there is no mutual shadow between the tables.

If two rows of Z3DP 380 within a V table are long enough to create a full string, they can be connected in series to create a string and create immunity to mutual shading with much fewer wires. In all such cases, if one row is shadowed, only the next row is compromised in terms of power generation, and all other rows are working fine.

FIG. 52 illustrates how a similar arrangement can apply to regular (flat) LPMs forming flat tables instead of V tables. In FIG. 51, an array of LPMs 408 may be arranged in solar farms to maximize energy production. Rows of LPMs (that can be bifacial so reflection 115 of the sunlight beam 100 reaches the back side of the LPM below and may cast shadow on one another) are arranged one above the other in a pallet similar to the arrangement on a southern-facing roof (FIG. 16) to create a table 391. Each row is comprised of one or more LPMs connected in series, that can be as long as half a string, so the current that flows in one row and returns in another row creates a full string. (String means multiple PV cells connected in series to generate the voltage that is required to enter the inverter (e.g. 800 volt, or 1500 volt), and can be achieved by connecting in series multiple standard PV panels, or new shading-resistant PV panels, or PV cells in a sealed PV modules, etc.). Each row is connected by wire 393 in series to a row of the same height in the next table, so the mutual shadow 171 is similar on both of them (see rows in string 1 515, string 2 516 and string 3 517. Each two connected rows deliver the current into a string inverter 395. All the inverters are located on the same side of the tables, so they are close to each other and creates an avenue of inverters that minimizes the need to connect electrical cables between the string inverters and the central inverter.

Multiple LPMs that are mounted one above the other to create one surface and are connected in parallel can also create a table which has immunity to self-shading.

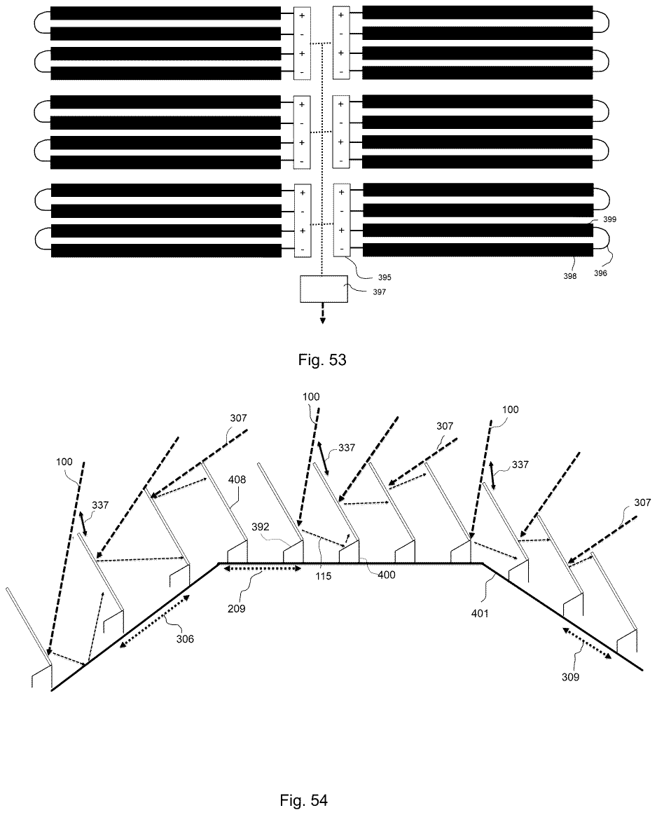

FIG. 53 illustrates schematically the string architecture for the tables of FIGS. 51 and 52. In this case (i.e., the configurations of FIG. 51 and FIG. 52), the string inverters 395 are located on the main avenue, reducing significantly the wires'length in such a deployment, and the power loss caused by it. Every two Z3DP rows are connected by a short wire 396 at the edge to create the string so the current is going forward 398 and backward 399. The string inverters 395 are then connected to the main power converter 397. This set up can be done also with any other type of PV modules.

### E. Reflective Surfaces for Bifacial Z3DP and Lpm

As discussed above in connection with FIG. 24 (in connection with gamma-shaped profiles), the functioning of the Z3DP and LPM may be enhanced with the use of mirrors. In this context, mirrors include all types of reflective surfaces, including reflective paint or reflective sticks.

The embodiment of FIG. 54 incorporates many of the elements previously recited herein, as well as the mirrors for enhancing the reflections for bifacial panels.

FIG. 54 shows a side view of an LPM in the shape of a bifacial flat LPM 408 with a mirror 392 on the bottom to reflect most of the sunlight beam during summer zenith 100 and winter zenith (307) and in all other seasons and day times to the back of the LPM adjacent to it, so flat profiles with bifacial PV cells can absorb the reflected light, which is a direct reflection and not only the general background radiation or defused radiation used usually by bifacial panels. On the right the deployment surface is tilted to the south (in the northern hemisphere), on the left it is tilted to the north and in the middle it has no tilting. In order for the sunlight beam 100 to collide with the PV surface and not with the roof, the gaps between the flat profiles on the northern roof 306 are larger than on the horizontal roof 209, and the gaps between the flat profiles on the horizontal roof are larger than on the southern roof 309. The gaps may be set according to the summer zenith, as discussed.

The LPM skeleton 400 is below the LPM in order not to cast shadow on it, as discussed in connection with previous embodiments. The infrastructure and the base frame 401 that holds the LPMs are also below the LPMs in order not to cast shadow on them.

In the illustrated embodiment, the mirror 392 is arranged in separate units at the base of each bifacial panel. In other embodiments, the mirror may be arranged as one unit at the bottom of the array.

The tilting angle of the LPMs can be set according to any or all the measured parameters, such as the tilting angle of the deployment surface, its azimuth and latitude. Here, condensing the rows of LPMs more than the typical gap (as defined above in connection with FIGS. 1-7) is what enables the structure to make use of the reflected sunlight beam efficiently. For that purpose, the angle between the flat roof in the middle and the LPM is larger than the angle facing the absorption direction by at least 10 degrees, sometimes by 20 or 30 or even up to 90 degrees. In tilted roofs, this angle stays the same relative to the absorption direction.

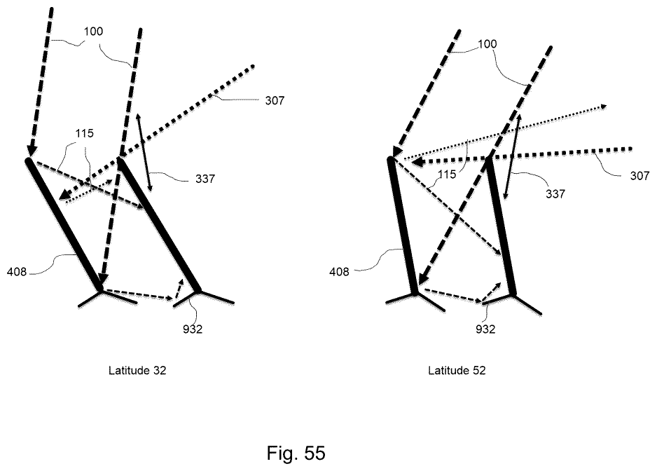

Based on simulations, the present inventors have determined that for an efficient bifacial structure, where at least 30% of the reflection from one LPM is directly aimed at the back of the LPM before it (and sometimes 50% or even 90%), the angle between summer zenith (100) and the LPM should be around 142 degrees. This angle is the same for any latitude. While a 142 degree angle maximizes total energy (the sum of energy generated at the front and rear faces of the bifacial panels), a 20 degrees deviation can still properly reflect most of the light for the bifacial purpose (called here bifacial angle) during most of the days and most of the hours in a day. This creates a large deployment angle between the deployment surface and the PV module (angle 518 in FIG. 2). As seen in FIG. 55, the tilting angle depends on the latitude. For example, as seen in FIG. 55, at 32 degrees latitude, because of the 142 degree angle mentioned above, the optimal tilting angle relative to the horizontal deployment surface is around 60°, plus or minus 20 degrees, when conventional solar panels have a tilting angle of 15-27 degrees. For a latitude of 52 degrees, the optimal tilting angle is around 80°.

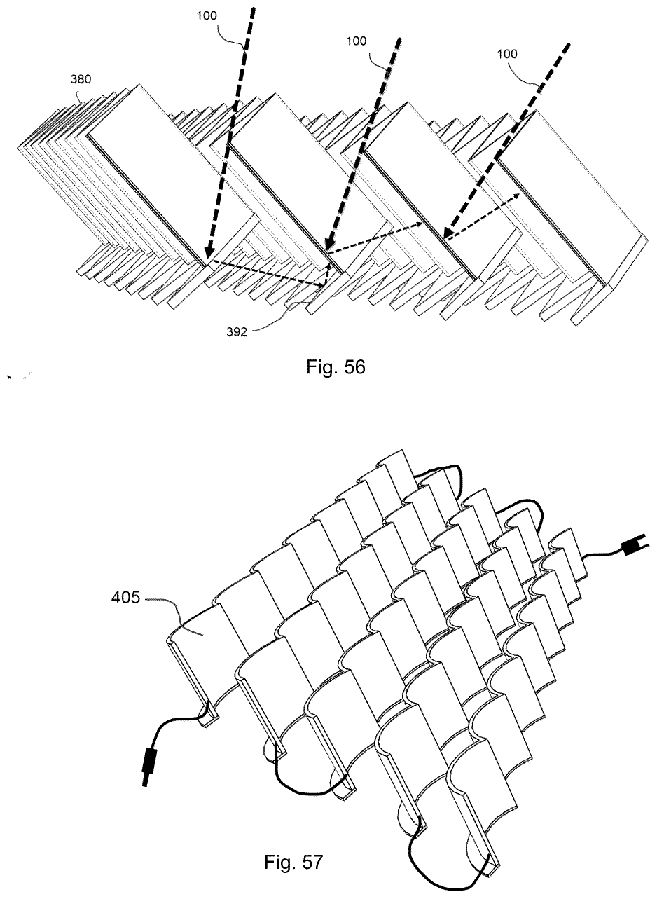

FIG. 56 shows the same bifacial design but for the Z3DP 380, while the mirror 392 reflects the light to the back of the Z3DP. As seen in FIG. 56, the improved density gap can be applied to deployments of 3DPs in general and specifically to Z3DPs as well.

A Z3DP may be comprised of any 3D PV units as long as it has the unique electrical connection as explained for the Z3DP which is based on parallel connection within the 3D PV units.

### F. Curved Shapes

FIG. 57 shows a Z3DP array comprised of arch shaped 3D PV units 405 instead of V units. This can be achieved in many ways, like using flexible PV cells, or spraying PV material on an arch structure.

### VII. Implementations With New Shading-Protected PV Panels

It is possible to solve some of the issues mentioned in this disclosure by positioning new shading-protected PV panels, as described in the '727 application in a bifacial angle as described above, as they have mutual shading immunity, either with small gaps facing south, or almost without gaps facing east and west, provided that each facing direction is connected to a separate string or the east-facing panels are connected in parallel to the west facing panels.

The structure in FIG. 54, which is designed to reflect light from one flat LPM and from the mirror directly to the back of the flat LPM adjacent to it, can be implemented also for flat LPMs that include more than one row of PV cells as explained earlier, provided that the PV cells in each row of the flat LPM are connected in series and the rows are connected in parallel. Such multi-row LPM can be framed to create another version of a New Shading-Protected PV Panel similar to what is described in the '727 application. However, advantageously, the panels which are bifacial in this case, will also function well under mutual shading conditions even if the parallel connections are between the rows.

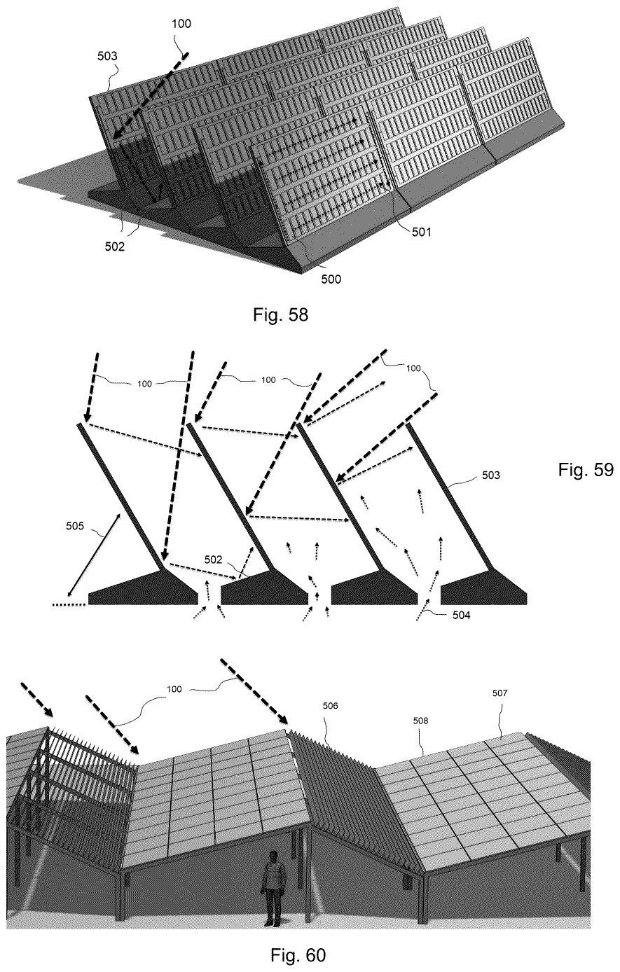

FIG. 58 shows an example on how LPMs are forming a new shading protected PV panel. In such a PV Panel 503 the narrow PV cells 500 in each row are connected in series and the rows of the narrow PV cells are connected in parallel. The cells are narrow in order to reduce the current so their height/width ratio can be from 2 (half cut cells) and up to 10. Arrows 501 show the direction of the current flow. Reflectors 502 reflect the sunlight beam 100 that comes from above, in addition to the light reflected from one bifacial new PV panel to the back of the bifacial new PV panel adjacent to it, and thus generates more energy (larger current and power). Here, condensing the rows of new PV panels more than the typical gap is what enables the structure to make use of the reflected sunlight beam efficiently.

FIG. 59 shows a schematic side view of the same structure that shows how the sunlight beam 100 in different seasons and day times is reflected directly to the back of the previous bifacial panel. This figure also demonstrates the cooling advantage that such a structure has, whether it is comprised of new PV panels or LPMs. The flow of cooling air can be seen by the small arrows 504, due to the large angle between them and the earth 505. This angle is larger than the angle facing the absorption direction by at least 10 degrees, sometimes by 20 or 30 or even up to 90 degrees. Better cooling means better power production, and the difference in hot weather can reach 20-40 degrees lower temperature in this angle relative to panels positioned according to the absorption direction.

### VIII. Miscellaneous Implementations

Referring to FIG. 60, there is an option to deploy pallets 506 between rows of regular PV panels 507 in a table 508 in order to make use of the gaps between them, when the sun is high in the sky.

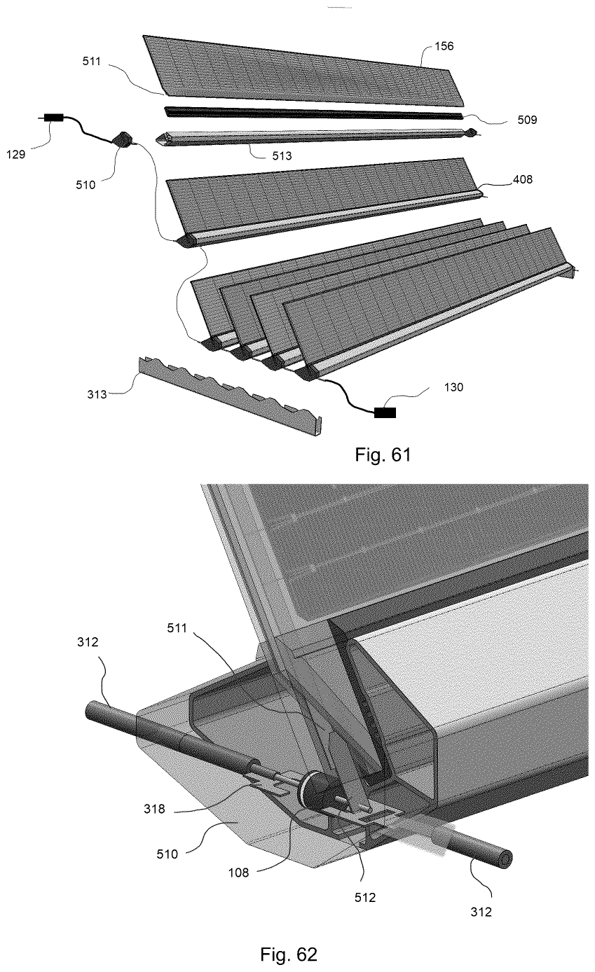

In order for the bifacial architecture to work well, the skeleton and the electrical connections should be designed in a way that minimize its self-cast shadow on the LPMs from both sides (front and back) and evenly distributing the shadow between all the PV cells, an example for which is described in FIG. 61. In order to achieve that, bifacial LPMs or their sealed PV modules should be supported only below the edge of the LPM that has the lowest exposure to the sunlight throughout the year (which is true also for PV panels).

The LPM 408 is comprised of sealed PV module 156 which is positioned inside a rubber profile 509 that mechanically holds and electronically isolates it from the aluminum profile 513, in which the rubber profile with the sealed PV module is inserted. The side unit 510 is connected to the busbar 511 that sticks out from the sealed PV module, and connects it to the previous and next LPM. The first and last LPMs are connected to connectors 130 and 129 accordingly). The base frame 313 is connecting mechanically all the LPMs to a pallet, while setting the distance between the LPMs and their tilting angle relative to the deployment surface. There is an option to use a reflective surface, like a mirror, at the bottom of the array, below the entire pallet or part of it, instead of a separate reflective surface for each LPM.

FIG. 62 is zoomed-in view of the inside of the side unit 510 of FIG. 61. A metallic contact 512 is connected to the electrical wire (which is an integral connector) 312 coming from the previous LPM and connecting it to the busbar 511 of this LPM. A bypass diode 108 connects the metallic contact to a bypass line 318.

### IX. Miscellaneous Combinations of the Inventions

The following enumerated paragraphs provide additional non-limiting aspects of the disclosure.

The present invention refers for example to a system that increases the safety and reliability of a PV installation by reducing the number of connectors. The System may include at least 2 rows of encapsulated PV cells. The PV cells in each row are electrically connected. The at least 2 rows are connected in series with integral flexible connectors.

Optionally, the at least 2 rows of PV cells are of similar length. The at least 2 rows of PV cells may alternatively be of different length.

The PV cells may be made of silicon.

The rows of the PV cells may be part of an FSSP. The FSSP may be connected to a strengthening frame.

The rows of the PV cells may be a part of a sealed PV module. The rows of PV cells are part of a PV cell strip.

The integral flexible connector may be based on continuation of the conductors of the PV cells before and after the integral flexible connector.

In another optional embodiment the invention may refer to a PV system that can face any desired direction on any deployment surface slope. This system includes one or more of the following: At least two LPMs which include a sealed PV module or PV cell strip. The LPMs may be connected in series and are mounted in parallel. The LPMs may be mounted on a rubber pad or similar material. The LPMs may be mounted on a rubber net or similar material.

The LPMs may be based on gamma-shaped profiles. The LPMs may be based on L-shaped profiles.

The gaps between the LPMs may be set according to at least one measured parameter of the deployment surface. The tilting angle of the LPMs may be set according to at least one measured parameter of the deployment surface.

The LPMs'skeleton may be attached to the sealed PV module below or behind so no shadow is cast by the skeleton on the sealed PV module in relevant sun angles.

The base frame may be mounted below or behind the LPMs so no shadow is cast by the base frame on the LPM in relevant sun angles.

The LPMs may be 3-dimensional.

Each LPM may be positioned within 30% from the smallest distance in which there is no self-shadow cast on the next LPM during zenith and in other sun angles there is self-shadow cast on the PV modules, which is similar for all the PV modules except for the first one.

The LPMs may be mounted along the shading lines due to a nearby building or other obstacle.

The LPM may be of different length than other LPMs.

The present invention in another embodiment refers to a system that may set PV cells to face the optimal direction. This system includes one or more of the following:

At least two LPMs which include a sealed PV module or PV cell strip. The LPMs may face a similar direction to the local absorption direction. The LPMs may be connected in series and mounted in parallel. The LPMs may be mounted on a rubber pad or similar material. The LPMs may be mounted on a rubber net or similar material. The LPMs may be based on gamma-shaped profiles. The LPMs may be based on L-shaped profiles.

The tilting angle of the LPMs may be set according to at least one measured parameter of the deployment surface. The gaps between the LPMs may be set according to at least one measured parameter of the deployment surface.

In another embodiment, the invention refers to a PV system that acts as a roofing solution. This system includes one or more of the following: At least two LPMs connected in series and mounted in parallel. The LPM skeleton may have no open holes that can cause water leaks. The LPMs may be mounted so that any water poured on them will flow to a gutter or outside of the roof, except that water poured on the overlapping part of two LPMs will flow to one of said LPMs.

The LPMs may face a similar direction to the local absorption direction. The LPMs may include a wing to set the PV cells in the desired tilt. The tilting angle of the LPMs may be set according to at least one measured parameter of the deployment surface. The gaps between the LPMs may be set according to at least one measured parameter of the deployment surface.

In another embodiment, the invention refers to a system that acts as a roofing solution. This system includes one or more of the following: At least two LPMs are connected in series and mounted in parallel. The angle towards the PV cells that are facing relative to the bottom of the LPM skeleton may be set during manufacturing or assembly.

In another embodiment the invention refers to a system that enables deployment on a roof slope. This system includes one or more of the following. An array of LPMs connected electronically in series and mounted in parallel on a base frame. The base can maintain the relative position between the LPMs while lifted in the air. A crane can lift the array and place it on said roof slope.

In another embodiment the invention refers to a PV system which accommodates daily shading patterns. This system includes one or more of the following. An array of LPMs is connected electronically in series and mounted in parallel. Each LPM is manufactured with a density of bypass solutions that match the need of its location on the deployment surface. The bypass solution can be controlled by a computer or a control processor.

In another embodiment, the invention refers to a PV system. This system includes one or more of the following: At least two LPMs are connected in series and mounted in parallel. The sealed PV module or the PV cell strip is connected to the LPM skeletons in a way that accommodates different lengthening during temperature changes. The way that accommodates different lengthening during temperature changes includes a rail.

In another embodiment, the invention refers to a system to maximize PV power generation on a deployment surface. This system includes one or more of the following: A plurality of connected Z3DPs is disclosed. The Z3DPs are mounted in parallel. The Z3DPs are facing similar direction. Said Z3DPs are arranged such that the amount of solar illumination on said vertical groups of said cells is similar in self-shading conditions, except for the larger illumination at some edges and the Z3DP facing the absorption direction. Said system has a 3-dimensional PV structure.

A plurality of base units may be connected below or behind of said modules for positioning said modules at a selected tilt. At least one Z3DP may have a different length than another module. The Z3DPs may be mounted at a similar distance between them.

The gaps between the Z3DPs may be set according to at least one measured parameter of the deployment surface. The tilting angle of the Z3DPs may be set according to at least one measured parameter of the deployment surface.

In another embodiment the invention refers to method to create a Z3DP. This method includes one or more of the following: Connecting a strip of PV cells so each two PV cells that are comprising a V shape are connected in parallel, front to front and back to back, while between the V shapes the connection is from the front of one V shape to the back of the next V shape. The method may further include setting the strip at zigzag shape. A plurality of base units may be connected below or behind of said Z3DPs for positioning them at a selected direction. At least one module may be in different length than another module. At least 3 Z3DPs may be mounted at a similar distance between them.

Another embodiment of the invention refers to a PV method for manufacturing a PV module for maximizing PV power generation on a deployment surface. This method includes one or more of the following: Bending top cover or manufacturing it in a zigzag structure, and laminating connected PV cells in between the top cover zigzag structure and the back. The lamination is conducted before the bending.

In another embodiment, the invention refers to a method for manufacturing or assembling an FSSP. This system includes one or more of the following: Measuring at least one of the parameters of the deployment surface; and setting at least one parameter of said FSSP according to at least one of said measurements. One of said measured parameters may be the latitude. One of said measured parameters may be the tilting angle of the roof. One of said measured parameters may be the slope azimuth of the roof. One of said measured parameters may be the shape and size of the roof slope The set parameter may be is the distance between the LPMs, the diagonal angle of the LPMs, the tilting angle of the LPMs, the length of the LPMs, and/or the size and shape of the FSSP. One of said measured parameters may be the local absorption direction.

In another embodiment the invention refers to a system to maximize PV power generation on a deployment surface. This system includes one or more of the following: A plurality of 3D PV units which are connected in series and facing similar direction. If there is more than 1 PV surface in each 3D PV unit, said PV surfaces within each 3D PV unit are connected in parallel. The 3D PV units are connected to create a Z3DP. There may be at least 2 Z3DPs laminated together under the same top cover. The parallel connection may be done within each 3D PV unit. Two flat LPMs may be positioned to create the shape of a V, and are connected in parallel at the edges. The left side of all the V shape 3D PV units of the 3DPs array can be connected together in series in one string, which is connected in parallel to another string that includes all the right side of all the V shape 3D PV units in the 3DPs array.

In another embodiment, a system to maximize PV electrical power generation on a deployment surface is disclosed. This system includes one or more of the following: A plurality of connected PV modules, each PV module comprising: a plurality of PV cells arranged in a row. At least one PV cell is in each vertical cross section of the row of said PV cells, whereas if there is a vertical group of more than one PV cell in each vertical cross section, said PV cells in said vertical group are electrically connected in parallel. Said each group of one or more PV cells in a vertical cross section is electrically connected in series to the group in the next cross section. The modules of PV cells may be mounted in parallel. The cross sections of said PV modules may be facing similar directions. The PV cell (or PV cells) in each cross section may be facing more than one direction. The PV modules may be arranged in an array so that the amount of solar illumination on said vertical groups of said PV cells is similar in self-shading conditions, except for some larger illumination at some edges. The PV cells may be made of silicon. Said system may have 3-dimensional PV structure.

A plurality of base units may be connected below or behind of said modules for positioning said modules at a selected direction. The PV modules may be positioned on base units so that said base units do not create any shading on any PV cell from the front and from the back.

Each PV module may be positioned within 30% from the maximum distance in which no photons collide with the deployment surface during summer zenith. Gaps between the LPMs are set as the maximum in which no photons collide with the deployment surface during summer zenith. At least one module may have a different length than another module. Said deployment surface may be a tilted roof. Said modules may be positioned at a similar distance between them. Said PV modules may be mounted above the infrastructure.

In another embodiment, a system to maximize PV power generation on a deployment surface is disclosed. This system includes one or more of the following: A plurality of 3D PV units which are connected in series. The PV surfaces within each 3D PV unit are connected in parallel. The 3D PV units are mounted in parallel and facing a similar direction.

In another embodiment, a method to position PV modules on a deployment surface is disclosed. This method includes one or more of the following: Calculating the local absorption direction; and positioning the PV modules up to 20 degrees of said local absorption direction.

In another embodiment, a system to improve PV power generation is disclosed. This system includes one or more of the following: A plurality of LPMs connected in series and mounted in parallel. The PV modules are mounted to face a similar direction to the local absorption direction, up to 20 degrees diversion. The gap between the LPMs is set based on summer zenith with up to 30% diversion.

In another embodiment the invention refers to a system to improve PV power generation. This system includes one or more of the following: Bifacial PV modules that are positioned so the light reflected from one PV module will collide with the back side of the next PV module in most sun angles. The system may be set so similar reflection light arrives to all PV cells, except for the edges and the last row of PV cells. Blank cells may be used to reflect light also on the edges. Blank cells may be used to reflect light also on the last row of PV cells.

In another embodiment, a method to position PV modules on a deployment surface is disclosed. This method includes one or more of the following: calculating the local absorption direction for preferred hours in the day; and positioning the PV modules up to 20 degrees of said local absorption direction.

In another embodiment, a system for maximizing PV power generation on a deployment surface is disclosed. This system includes one or more of the following: Top cover at a 3-dimensiional structure encapsulated PV cells; and a back cover. The 3-dimensiional structure may be in the shape of a V unit. The 3-dimensiional structure may be in the shape of a zigzag.

There may be minimum of 2 systems connected in series to create a zigzag structure. Said PV cells may be connected along the zigzag lines. Said PV cells may be connected along the lengthened dimension of the Z3DP. Said system may be comprised of at least two rows of PV cells connected in parallel.

In another embodiment, a method to connect PV cells in a row is disclosed. This method includes one or more of the following: Connecting a strip of PV cells comprised of groups of PV cells; connecting each group of PV cell in parallel, front to front and back to back; and connecting the front conducting wire of one group of PV cells to the back-conducting wires of the next group of PV cells. The group of PV cells may include 2 PV cells.

In another embodiment, the invention refers to a system of connected PV cells in a strip. This system includes one or more of the following: a strip of PV cell comprised of groups of PV cells; in which each group of PV cells is connected in parallel, front to front and back to back. The front conducting wire of one group of PV cells is connected to the back-conducting wires of the next group of PV cells in series. The group of PV cells includes at least 2 PV cells. The strip of PV cells forms a Z3DP.

In another embodiment, a FSSP system is disclosed. This system includes one or more of the following: A plurality of LPMs connected in series and mounted in parallel, wherein said LPMs face a similar direction. The direction the LPMs are facing is set based on at least one measured parameter of the deployment surface. The direction the LPMs are facing may be up to 20% of the local absorption direction.

In another embodiment, the invention refers to a system for maximizing PV power generation on a deployment surface. This system includes one or more of the following:
A plurality of LPMs is connected in series and mounted in parallel. Said LPMs may face a similar direction. The gap between the LPMs is set based on summer zenith with up to 30% diversion.

In another embodiment, the invention refers to a system to maximize PV electrical power generation on a deployment surface by allowing for a uniform distribution of light and shadow across vertical cross sections of the PV modules. This system includes one or more of the following a plurality of connected PV modules, each PV module comprising a plurality of PV cells arranged in a row. At least one PV cell is in each vertical cross section of the row of said PV cells, whereas if there is a vertical group of more than one PV cell in each vertical cross section, said PV cells in said vertical group are electrically connected in parallel. Each group of one or more PV cells in a vertical cross section may be electrically connected in series to the group in the next cross section. Said PV modules of PV cells may be mounted in parallel. Said cross sections of said PV modules may face a similar direction, and said PV modules may be deployed in rows which are positioned at a similar gap between them. Said PV modules may be mounted above the infrastructure. Said PV cells, or the group of PV cells, in each vertical cross section is facing more than one direction. Said PV modules may be arranged in an array so that the amount of solar illumination on said vertical groups of said PV cells is similar in self-shading conditions, except for some larger illumination at some edges and on the first row. Said gaps between said rows may be smaller than the improved density gap. Said system may have a 3-dimensional PV structure. A plurality of base units may be connected below or behind of said modules for positioning said modules at a selected direction. The PV modules may be positioned on the skeleton, so it provides the same level of light from the back except for the edges and for the last module. Each PV module may be positioned within 30% from the maximum distance in which no photons collide with the deployment surface during summer zenith. At least one module may be in different length than another module. Said deployment surface may be a tilted roof and the PV modules are deployed at a different tilting angle than the deployment surface by at least five degrees. Said PV modules may be Z3DP, 3DP, and/or LPM. The PV modules may be positioned in a 3-dimensional array.

What is claimed is:

1. An array of lengthened photovoltaic modules, each module comprises of bifacial photovoltaic cells, wherein a deployment angle and a gap between adjacent modules is set so that a portion of light incident on the forward face of each module is reflected onto a rear face of an adjacent module in the array.

2. The array of claim 1, wherein the array includes a reflective surface on the bottom of the array that reflects light to the rear face of the adjacent module.

3. The array of claim 2, wherein the reflective surface comprises a plurality of reflective surfaces, wherein each reflective surface is configured at a base of a module.

4. The array of claim 2, wherein the reflective surface comprises one or more of reflective paint, a reflective stick, or a mirror or a mirror level polished aluminum.

5. The array of claim 1, wherein the deployment angle is set at 142 degrees relative to summer zenith ±20 degrees

6. The array of claim 5, wherein the modules are condensed relative to each other closer than a typical gap by 50%, wherein a typical gap is defined as a gap that is configured to prevent self-shading between adjacent modules at winter active hours.

7. The array of claim 5, wherein the gap between said modules is set according to summer zenith ±plus minus 50%.

8. The array of claim 5, wherein the gap between said modules is set to cast self-shadow during 20% of the winter active hours.

9. The array of claim 5, wherein the gap between said modules is set to cast self-shadow during 40% of the winter active hours.

10. The array of claim 5, wherein the array is a 3-dimensional structure.

11. The array of claim 5, wherein the array is a 3-dimensional array.

12. The array of claim 5, wherein the LPMs are supported only below the edge of the LPM that has the lowest exposure to the sunlight throughout the year.

13. The array of claim 5, whereas the LPMs are forming a new shading protected PV panel.

14. The array of claim 7, whereas the LPMs are forming a new shading protected PV panel.

15. The array of claim 9, whereas the LPMs are forming a new shading protected PV panel.
